(19) United States
(12) Patent Application Publication
(10) Pub. No.: US 2016/0129349 A1
(43) Pub. Date: May 12, 2016

(54) SOCIAL VIDEO GAME METHOD, APPARATUS, AND SYSTEM

(71) Applicant: Dreamics Limited, Beijing (CN)

(72) Inventors: Yongkai Zhao, Beijing (CN); Yuntao Zhou, Beijing (CN); Ke Ma, Beijing (CN); Zhilong Gu, Beijing (CN)

(21) Appl. No.: 14/539,654

(22) Filed: Nov. 12, 2014

(51) Int. Cl. A63F 13/537; A63F 13/46; A63F 13/35

(52) U.S. Cl. CPC A63F 13/537; A63F 13/35; A63F 13/46

(57) ABSTRACT

A computer-implemented method of playing a game includes displaying a first plurality of game elements on the display device, receiving a selection from the user, wherein the selection comprises a first game element of the plurality of game elements and at least one second game element of the plurality of game elements, and wherein an appearance of the first game element matches an appearance of the at least one second game element, displaying the selection as an enclosed area that encompasses the first game element and the at least one second game element, determining a second plurality of game elements, wherein each of the second plurality of game elements have an appearance that matches the appearance of the first game element and are located within the selection, and calculating a target score wherein the target score is based on a number of the second plurality of game elements.

### BACKGROUND

The invention relates to interactive games.

### SUMMARY

A computer-implemented method of playing a video game, a system, and a computer-readable medium therefor are disclosed. The computer may be a mobile computing device having a processor, a memory, a visual peripheral output device, an audio peripheral output device, and a motion sensor. In another embodiment, an article of manufacture is provided. The article of manufacture comprises a machine-accessible medium having instructions encoded thereon for enabling a processor to perform the operations of the computer-implemented method disclosed herein. In yet another embodiment, a system further comprises a mobile device. The mobile device comprises a processor, a motion sensor, a memory subsystem, a visual peripheral output device, and an audio peripheral output device. The memory subsystem is encoded with instructions for enabling the mobile device to perform the operations of the computer-implemented method disclosed herein.

### DESCRIPTION OF THE FIGURES

The novel features of the various embodiments are set forth with particularity in the appended claims. The various embodiments, however, both as to organization and methods of operation, together with the advantages thereof, may be understood by reference to the following description taken in conjunction with the accompanying drawings as follows.

FIG. 1 is a display of a plurality of game map screens of a video game according to embodiments of the present disclosure.

FIG. 2 is a display of a game map of the video game according to an embodiment of the present disclosure.

FIG. 3 is a display of a plurality of game level icons according to an embodiment of the present disclosure.

FIG. 4 is a display of a restore life points menu according to an embodiment of the present disclosure.

FIG. 5 is a display of a in-game currency menu according to an embodiment of the present disclosure.

FIG. 6a is a display of a game settings menu according to an embodiment of the present disclosure.

FIG. 6b is a display of a game settings menu according to another embodiment of the present disclosure.

FIG. 7a is a display of a game instruction screen according to an embodiment of the present disclosure.

FIG. 7b is a display of a game instruction screen according to another embodiment of the present disclosure.

FIG. 8 is a display of a game map according to an embodiment of the present disclosure.

FIG. 9 is a display of an unlocking level menu according to an embodiment of the present disclosure.

FIG. 10 is a display of a game level according to an embodiment of the present disclosure.

FIG. 11 is a display of a game board according to an embodiment of the present disclosure.

FIG. 12 is a display of a game board according to an embodiment of the present disclosure.

FIG. 13 is a display of a game board according to another embodiment of the present disclosure.

FIG. 14 is a display of a settings menu according to an embodiment of the present disclosure.

FIG. 15 is a display of a selection process according to an embodiment of the present disclosure.

FIGS. 16a and 16b is a display of instruction screen showing a selection process according to an embodiment of the present disclosure.

FIGS. 17a and 17b is a display of screen showing animation of a selection process according to an embodiment of the present disclosure.

FIG. 18 is a display of a portion of a game board according to an embodiment of the present disclosure.

FIGS. 19a and 19b is a display of screens showing a selection box according to an embodiment of the present disclosure.

FIG. 20 is a display of a game level according to an embodiment of the present disclosure.

FIG. 21 shows a plurality of standard game elements according to embodiments of the present disclosure.

FIG. 22 is a display of a screen showing embodiments of special game elements according to an embodiment of the present disclosure.

FIG. 23 shows a plurality of special game elements according to embodiments of the present disclosure.

FIG. 24 is display of a screen that shows the creation of a special game element according to embodiments shown in FIG. 23.

FIG. 25 is display of a screen that shows the creation of a special game element according to embodiments shown in FIG. 23.

FIG. 26 is display of a screen that shows the creation of a special game element according to embodiments shown in FIG. 23.

FIGS. 27 and 28 are displays of screens showing animations of the effect of special game elements according to embodiments shown in FIG. 23.

FIG. 29 shows a plurality of special game elements according to embodiments of the present disclosure.

FIG. 30 is display of a screen that shows the creation of a special game element according to embodiments shown in FIG. 29.

FIGS. 31a-32 are displays of screens showing animations of the effect of special game elements according to embodiments shown in FIG. 29.

FIG. 33 shows a plurality of special game elements according to embodiments of the present disclosure.

FIGS. 34a-35 are displays of screens showing animations of the effect of special game elements according to embodiments shown in FIG. 33.

FIGS. 36-41 show a plurality of blocker game elements according to embodiments of the present disclosure.

FIG. 42 is a display of a game level according to an embodiment of the present invention.

FIGS. 43-47 show a plurality of booster items according to embodiments of the present disclosure.

FIGS. 48-52 are display of screens showing animations of bonus rounds of the game according to embodiments of the present disclosure.

FIG. 53 is a display of a game level according to an embodiment of the present invention.

FIG. 54 is a display of a screen showing a selection box and a blocker game element according to an embodiment of the present invention.

FIG. 55 is a display of a screen showing animation associated with a blocker game element according to an embodiment of the present invention.

FIG. 56 is a display of a game level according to an embodiment of the present invention.

FIG. 57 is a display of a screen showing game elements of a game level according to an embodiment of the present invention.

FIG. 58 is a display of a game level according to an embodiment of the present invention.

FIGS. 59 and 60 are displays of screens showing animations associated with a game level according to embodiments of the present invention.

FIG. 61 is a display of a completion screen according to an embodiment of the present invention.

FIG. 62 is a display of a game level summary screen according to an embodiment of the present invention.

FIG. 63 is a display of a failed level screen according to an embodiment of the present invention.

FIG. 64 is a display of a failed level summary screen according to an embodiment of the present invention.

FIG. 65 is a display of a notification screen according to an embodiment of the present invention.

FIG. 66 is a display of an initial game screen according to an embodiment of the present invention.

FIG. 67 is a display of a game map according to an embodiment of the present invention.

FIG. 68 is a display of a social network service screen according to an embodiment of the present invention.

FIG. 69 is a display of a notification screen according to an embodiment of the present invention.

FIG. 70 shows a schematic view of an illustrative electronic device.

FIG. 71 shows one embodiment of an input/output subsystem for an electronic device.

FIG. 72 shows one embodiment of a communications interface for an electronic device.

FIG. 73 shows one embodiment of a memory subsystem for an electronic device.

### DETAILED DESCRIPTION

Various embodiments are described to provide an overall understanding of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting embodiments and that the scope of the various embodiments is defined solely by the claims. The features illustrated or described in connection with one embodiment may be combined, in whole or in part, with the features of other embodiments. Such modifications and variations are intended to be included within the scope of the claims.

A description of a preferred embodiment of the present disclosure is a game with a story background as follows: Jelly Prince and Princess were living on the Jelly Island. When they were having a picnic, Jelly Princess was kidnapped by little monsters. Hence, the Player and Jelly Prince embarked on the journey to rescue the Jelly Princess and protect Jelly Island. When the Player completes a game level on the map, it will unlock the next new game level, driving the next development in the storyline and ultimately leading to Princess's rescue.

A computer-implemented method of playing a game is disclosed herein. The computer comprises a processor, a non-transitory memory, a display device for displaying information to a user, and an input device for receiving information and commands from the user, and the method comprises displaying a first plurality of game elements on the display device, receiving, via the input device, a selection from the user, where the selection comprises a first game element of the plurality of game elements and at least one second game element of the plurality of game elements and an appearance of the first game element matches an appearance of the at least one second game element, displaying the selection as an enclosed area that encompasses the first game element and the at least one second game element, determining, by the processor, a second plurality of game elements, where each of the second plurality of game elements have an appearance that matches the appearance of the first game element and are located within the selection, and calculating a target score, by the processor, wherein the target score is based on a number of the second plurality of game elements.

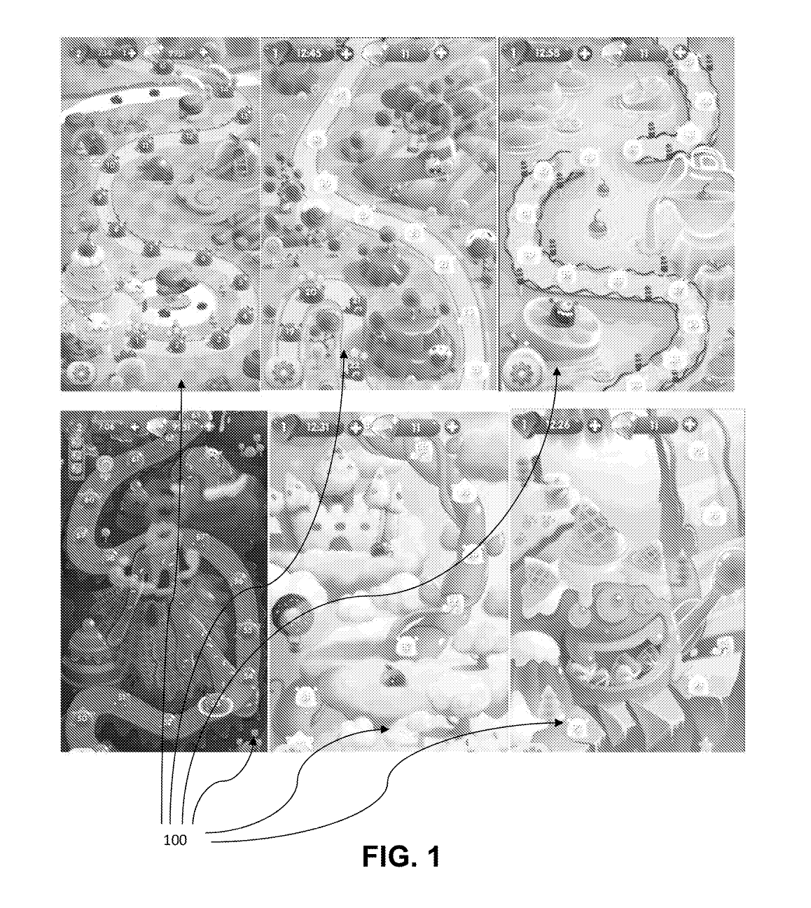

In an embodiment, the video game has a plurality of game maps as shown in FIG. 1, and each game map with its own unique features. A game map is an area where a user can select a game level and view current game progress, a number of life points, and a quantity of in-game currency. While FIG. 1 illustrates six game maps 100, the number of game maps may be more or less than six and the configuration and visual appearance of each game map may vary. Each game map 100 may have a thematic appearance that is carried throughout all aspects of the display of the game map 100. On a game map, different levels are represented by game level icons that have different appearances, for example based on distinguishing colors and/or distinguishing shapes. In addition, game regions, which are different areas on the game map that have unique themes and features, may subdivide a game map 100.

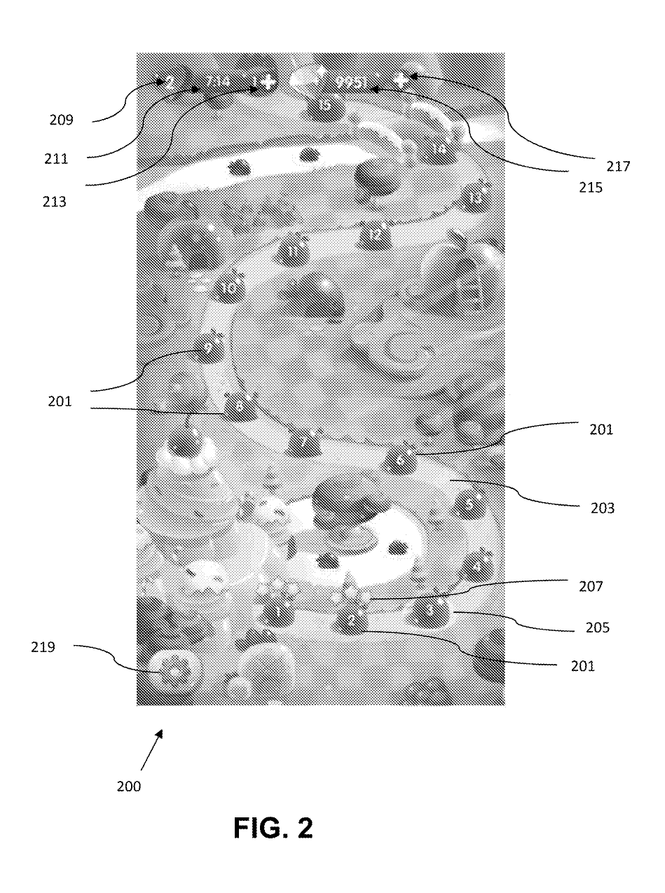

FIG. 2 shows an embodiment of a game map 200 that is displayed in a screen of the video game when it is in the game map mode. The game map 200 presents one or more game level icons 201 to a user, which may also be referred to as a “Player”, such that the user may select a particular game level in order to play the game. Each game map 200 may have a series of game levels that fit within a common structure, where the common structure may be based on appearance, gameplay, and/or game elements, among other things. Thus, the game level icons 201 and game map 200 may have a corresponding appearance. The game level icons may be displayed on a pathway 203 and have numbers displayed thereon that increase in order as viewed from the bottom of the game map to the top of the game map. In other embodiments, the pathway 203 and the game level icons 201 may be arranged randomly or haphazardly.

The game level icons 201 may be shown as substantially identical shapes (which may be different based on a viewing perspective or arrangement of the shape) or they may be shown as distinguishable shapes. Additionally, the appearance of a game level icon 201 may indicate that the level is default or normal level, where gameplay has a normal approach. A normal approach to gameplay may be based on, for example, the level of involvement of the player, the type or number of moves allowed by the player, the game elements, and hence the characters, that appear. Additionally, the appearance of the game level icon 201 may indicate that the game level is a special level where gameplay has a special approach. A special approach to gameplay may be based on similar attributes as a normal approach, for example, the level of involvement of the player, the type or number of moves allowed by the player, the game elements, and hence the characters, that appear.

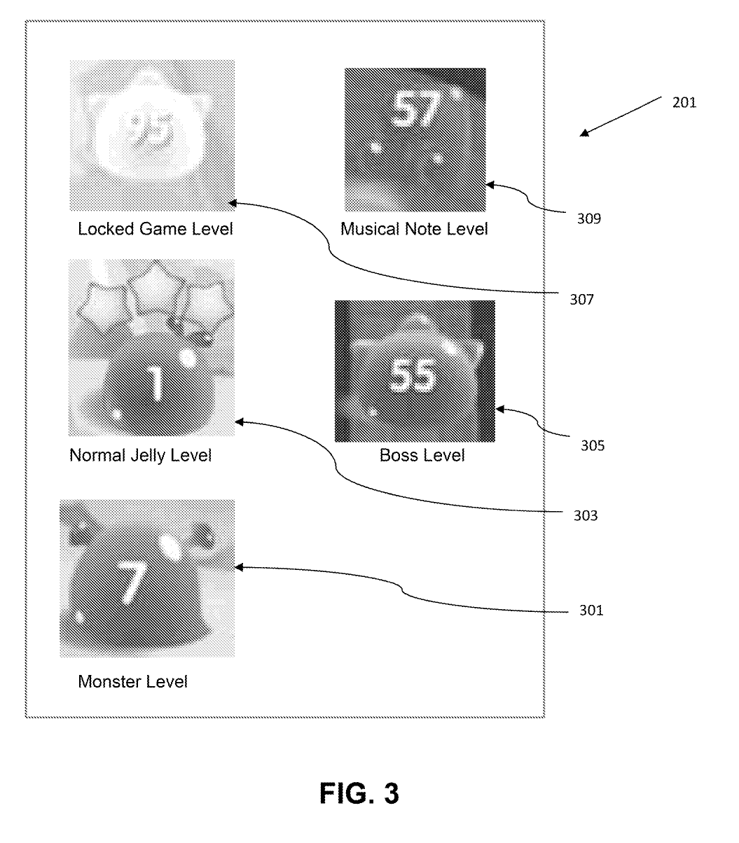

A plurality of game level icons is shown in FIG. 3. In one embodiment, there are five different appearances for game level icons 201 and each game level that corresponds to a particular game level icon 201 may involve different attributes of gameplay according to the appearance of the game level icon 201. Additionally, there may be other or additional appearances for game level icons than those shown in FIG. 3. As shown in FIG. 3, game level icons 201 may comprise a “Monster Level” 301, a “Normal Jelly Level” 303, a “Boss Level” 305, a “Locked Game Level” 307, and a “Musical Note Level” 309. A further description of the gameplay associated with the game levels that correspond to these game level icons 201 is provided below.

As shown in FIG. 2, a game level selection indicator 205 provides a visual cue to the user for selecting a desired game level icon 201. As shown in FIG. 2, the game level selection indicator 205 is a highlighted region surrounding the game level icon and may be moved in a serial fashion between game level icons 201 for selecting a particular game level icon 201. In other embodiments, the game level selection indicator 205 can take on various configurations and visual appearances. Furthermore, as shown in FIG. 2, a game level completion indicator 207 may be displayed to indicate that a game level has been completed. Accordingly, after a game level is completed, the game level icon 201 in a game map 200 corresponding to a completed game level may be displayed with the game level completion indicator 207. The game level completion indicator 207 is displayed above, as in FIG. 2. In other embodiments, the game level completion indicator 207 may be displayed in addition to or instead of the game level icon 201. According to the embodiment of FIG. 2, a series of three stars above the game level icon 201 are displayed as the game level completion indicator 207. In other embodiments the game level completion indicator 207 can take on various configurations and visual appearances to indicate that a game level has been completed. In other embodiments, the game level icon 201 itself may change its appearance to indicate that a game level has been completed, such as for example, based on color and/or shape.

Additionally, the game level completion indicator 207 may be configured in a fashion to provide an indication of a user's success in completing a particular game level. For example, a shown in FIG. 2, the series of three stars, which represent the game level completion indicator 207, are displayed as solid shapes, with each of the three stars having a filled-in appearance. This indicates a user achieved a score in a range associated with a high score when completing the level. Accordingly, if two of the stars were displayed with a filled-in appearance, this would indicate the user achieved a lower score, in a range associated with a medium score when completing the level. Accordingly, if one of the stars was displayed with a filled-in appearance, this would indicate the user achieved an even lower score, in a range associated with a lowest score when completing the level. As with the game level completion indicator 207, the indication of a user's success may take on various configurations and visual appearances, for example the displayed range of success may be more or less than three indications as shown in FIG. 2.

Also in FIG. 2, a life point indicator 209, a life point timer 211, a life point addition icon 213, a currency indicator 215, a currency addition icon 217, and a game settings icon 219 are shown. The life point indicator 209 displays the number of life points or lives associated with a user. Each life point allows a user a chance to complete one game level and a life point may be required for a user to play a game level. In the embodiment shown in FIG. 2, the user's available life points are displayed on the life point indicator 209 which is a red, heart-shaped icon on the upper left corner of the game map 200. In one embodiment, if a user completes a game level, a life point is not deducted from the total shown in the life point indicator 209, however, if a user is unable to complete the game level a life point is deducted and the use is given the opportunity to play the level over again. In another embodiment, a life point is deducted every time a user begins a game level. In addition, the total number of life points that a user may accrue may vary. In one embodiment, the user can accrue up to a maximum of five life points. Additionally, a user may be able to increase the maximum number of life points that can be accrued using in-game currency.

If a user has run out of life points, in one embodiment, the user may wait 60 minutes in order to gain a new life point. The life point timer 211 displays an amount of time that a user may be forced to wait before a new life point is allotted. In one embodiment, when the number of life points shown in the life point indicator 209 is at the maximum, the life point timer 211 may display a message, such as, for example “full”. A user may also be able to request lives from a second user of the game associated with the user on a social networking service, such as Facebook®. Requesting and sending life points between friends or contacts of a social networking service may be free for both the user and the friend associated with the user, or it may require a user or friend to perform a task, such as viewing an advertisement, or provide some form of payment, similar to those discussed below.

As shown in FIG. 2, the currency indicator 215 displays the amount of in-game currency associated with a user. In-game currency is a feature that allows a user to purchase special items or certain aspects associated with the game. For example, in one embodiment a user may be able to buy booster items, add more life points, and/or add additional selections or moves in the game. A user may also be able to increase the maximum amount of accrued life points using in-game currency and this may be done permanent or on a temporary basis. A user may receive in-game currency based on a purchase to an online monetary platform associated with the game by using a credit card or another form of money transfer, such as PayPal®. In other embodiments, the user may receive in-game currency based on an intermediate monetary platform, such as for example, iTunes® credits. Similar to the life point addition icon 213, a user may be able to access avenues for obtaining additional in-game currency by selecting the currency addition icon 217 and activation of the currency addition icon 217 provides an appropriate interface for the user to obtain additional in-game currency. In one embodiment, a form of in-game currency is referred to as “diamonds” and displayed with a symbol of a diamond in the in-game currency indicator 215 as shown in FIG. 2.

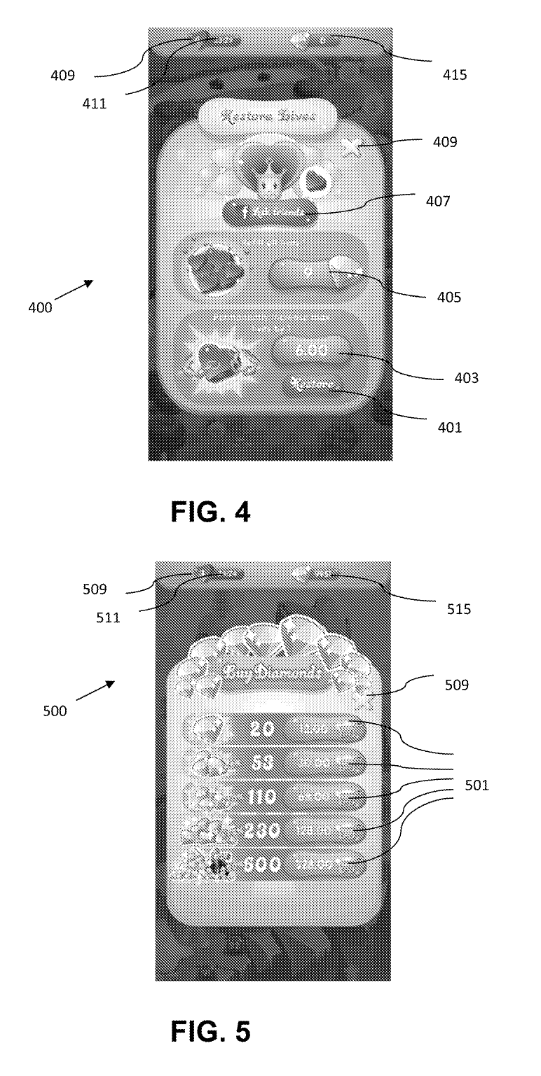

FIG. 4 shows an embodiment of a screen having a restore life points menu 400 whereby a user may restore life points. In one embodiment, the menu 400 appears automatically upon the user exhausting all life points. In another embodiment, the user may access the menu 400 by activating a link, an icon or other means. The user may restore life points by activating the restore icon 401, which may be restore a single life point or more than one life point at a time. A user may also increase a maximum allotted number of life points using icon 403. A user may also refill all lives at once, using icon 405. A user may also request life points from a second user of the game associated with the user on a social networking service, using icon 407. Various ranges of in-game currency, intermediate currency, or standard currency may be required to restore life points based on which icon 401, 403, 405, 407 is activated by a user. Additionally, changes made to the number of life points may be displayed by the life points indicator 409 and the life point timer 411 may also run during the time the screen 400 is active. In addition, the in-game currency indicator 415 may be updated according to an amount of in-game currency used to restore life points as appropriate. Further, icon 409 allows a user to exit the menu 400. A user may be able to access the avenues described or additional avenues for obtaining additional life points by selecting the life point addition icon 213, shown in FIG. 2, which provides an appropriate interface for the user to obtain additional life points.

An embodiment of an in-game currency menu 500 is shown in FIG. 5. In one embodiment, the menu 500, a user may purchase in-game currency with an intermediate currency, such as iTunes credits, or standard currency, which may be accessed via a credit card or PayPal® account. As shown in FIG. 5, a plurality of icons 501 may be presented by menu 500 to allow a user to choose a desired amount of in-game currency, represented as diamonds, by activating the appropriate icon. In another embodiment, a user may be able to input a number indicating a desired amount of in-game currency instead of or in addition to icons 501. Additionally, changes made to the number of life points may be displayed by the life points indicator 509 and the life point timer 511 may also run during the time the menu 500 is active. In addition, the in-game currency indicator 515 may be updated according to an amount of in-game currency purchased as appropriate. Further, icon 509 allows a user to exit the menu 500.

As mentioned, a user may purchase diamonds using intermediate currency, such as iTunes® credits, and an exemplary rate structure purchasing diamonds is:
20 diamonds for 1.99 ITunes credit
53 diamonds for 4.99 ITunes credit
110 diamonds for 9.99 ITunes credit
230 diamonds for 19.99 ITunes credit
600 diamonds for 49.99 ITunes credit

Additionally, in another embodiment, a user may purchase special items or certain aspects associated with the game directly by bypassing an in-game currency conversion. For example, a user may be able increase the maximum amount of accrued life points by one by paying 0.99 iTunes® credit. A user may be able to access the avenues described or additional avenues for obtaining additional in-game currency by selecting the currency addition icon 217, shown in FIG. 2, which may provide an appropriate interface for the user to obtain additional in-game currency.

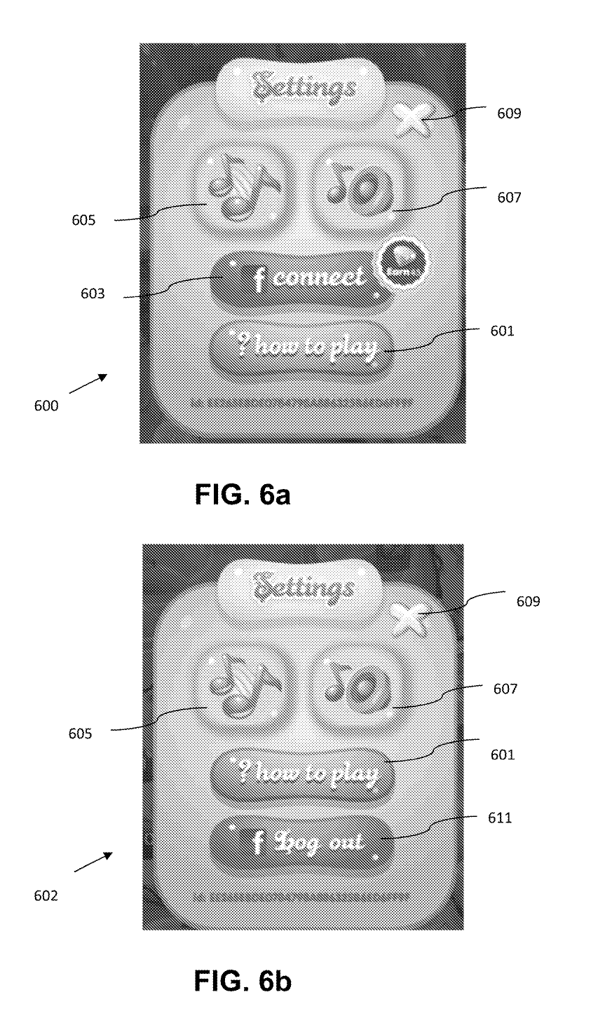

A game setting icon 219 is also shown in FIG. 2. The game setting icon 219 is displayed as a gear icon in the embodiment of FIG. 2 and may take on other shapes and configurations in other embodiments. In one embodiment, a user can access a game settings menu at any point in the game, whether game map mode or game level mode, using the game setting icon 219. In one embodiment, a user can turn on or off in-game music or special effect sounds via the game settings icon 219. An embodiment of game settings menus 600, 602 that are displayed when a user activates the game settings icon 219 are shown in FIGS. 6a and 6b.

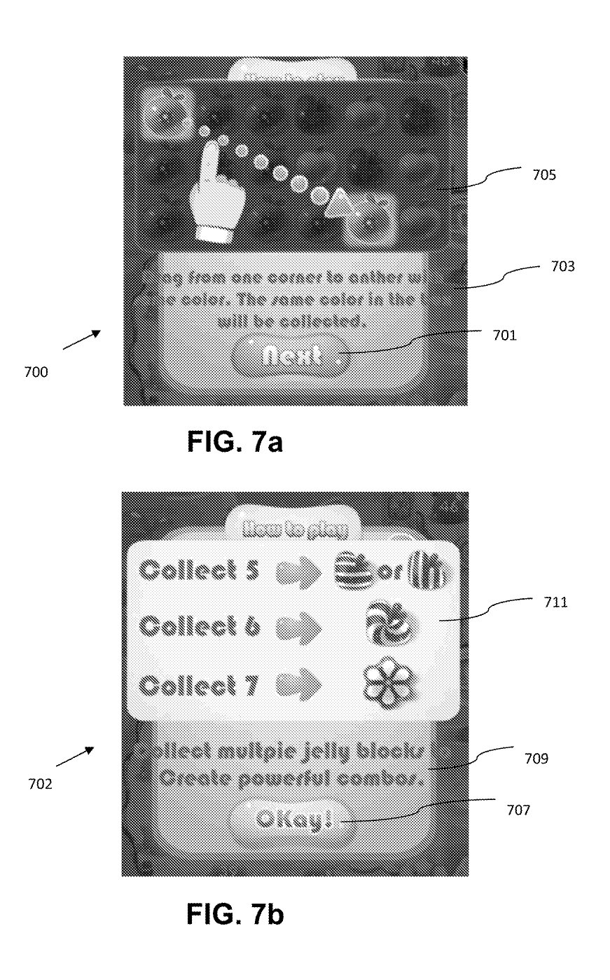

The menu 600 may have a game instructions icon 601, a social networking services icon 603, an in-game music icon 605, and a special effect sounds icon 607. The game instructions icon 601 allows a user to view a summary of instructions on the principles of the game and how to play the game. FIGS. 7a and 7b illustrate embodiments of game instruction screens 700, 702 that are displayed by activating the game instructions icon 601. A first game instruction screen 700 has a first section 703 and a second section 705 and an advance screen icon 701. The first section displays a textual message to the user regarding an animation and/or that is shown in the second section 705. In the embodiment shown in FIG. 7a, the second section 705 displays an animation that instructs a user on the way to make a proper selection of game elements. The first section 703 provides the textual message “Drag from one corner to another with same color. The same color is the box will be collected.” while the animation in the second section 705 is being played. By activating the advance screen icon 701 a new screen of additional instruction is displayed, such as the second game instruction screen 702.

Similar to the first game instruction screen 700, the second game instruction screen 702 has a first section 709 and a second section 711. Screen 700 also presents an acknowledgement icon 709. The first section displays a textual message to the user regarding an animation and/or message that is shown in the second section 711. In the embodiment shown in FIG. 7b, the second section 711 displays an message regarding the number of standard game elements that are needed for a special game element to provided to the user. The first section 709 provides the textual message “Collect multiple jelly blocks to create powerful combos.” while the message in second section 711 is being displayed. By activating the acknowledgement icon 709 a new screen of additional instruction may be displayed, or the game may return the user to the settings menu 600.

Referring back to FIG. 6a, by activating the social networking services icon 603, a user is provided the ability to the connect with other users of the game that are also connected with the user via a social networking service, such as for example, Facebook. By activating the social networking services icon 603 as user may be presented with an appropriate interface according to a particular social networking service or application. Further, the in-game music icon 605 allows a user to turn on or turn off in-game music and a special effect sounds icon 607 allows a user to turn on or turn off special sound effects that are played during gameplay. In addition, an exit icon 609 allows the user to close the settings menu.

FIG. 6b displays a settings menu 602 that may be presented to a user upon activation of the game setting icon 219 while the user is connected to a social networking service. The game instructions icon 601, the in-game music icon 605, and the special effect sounds icon 607 may function as described. The social networking services icon 611 allows a user to log out of, or disconnect from, a social networking service that the user was logged in to.

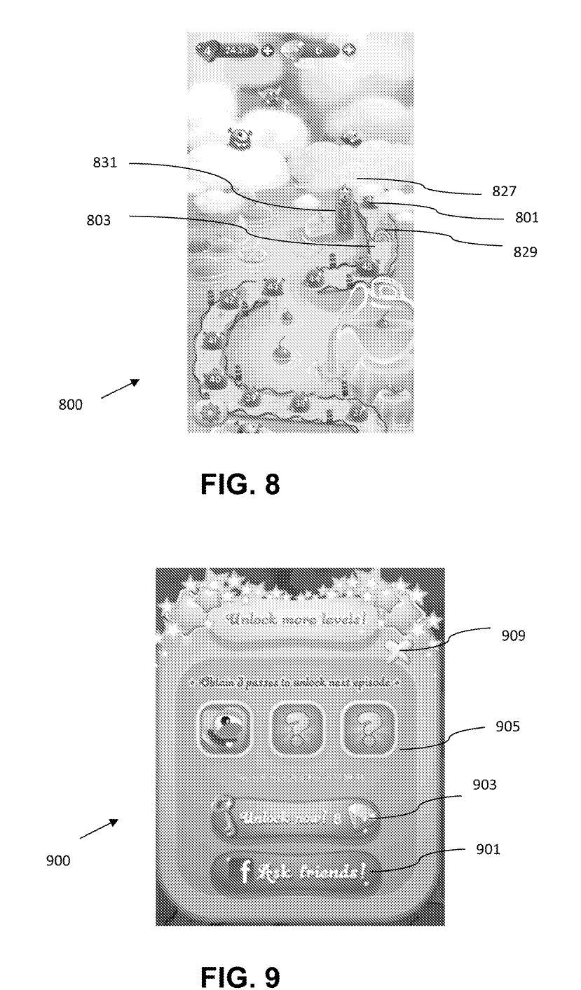

FIG. 8 shows an embodiment of a game map 800, similar to the game map 200 if FIG. 2, that is displayed in a screen of the video game when it is in the game map mode. The game map 800 is displayed when a user has reached a certain game level and the user is blocked from accessing higher levels by an obstruction 803. The obstruction 803 may be shown in the representation of the game map 800, for example, as shown in FIG. 8, clouds block the view of the pathway 803 and game level icons 801 and a path blocking icon 831 may be displayed. A user may have to complete a special pathway blocking game level, which is represented by a special game level icon 829, a predetermined number of times to be able to pass the obstruction 803. The path blocking icon 831 may display an indicator of how times out the predetermined number of times that the user has completed the pathway blocking game level.

In addition, a user may be able to activate the path blocking icon 831 such that the unlocking level menu 900 is displayed. An embodiment of the unlocking level menu 900 is displayed in FIG. 9 and the unlocking level menu 900 has an ask friends icon 901, an unlock level icon 903, a pass display 905, and an exit icon 909 that allows the user to close the menu 900. The ask friends icon 901 may allows a user to request assistance in completing a pathway blocking game level, either by receiving passes to complete the level or by receiving helpful hints or instructions. The unlock level icon 903 allows a user to complete pathway blocking game level and unlock higher levels using in-game currency. The pass display 905 shows how many passes a user has obtained with regard to the pathway blocking game level. A user may be required to obtain three passes in order to move beyond the pathway blocking game level and a pass may be received each time the user completes the pathway blocking game level. Further, the amount of in-game currency required to unlock higher levels may be dependent on the number of passes the user has earned, which are displayed in the pass display 905.

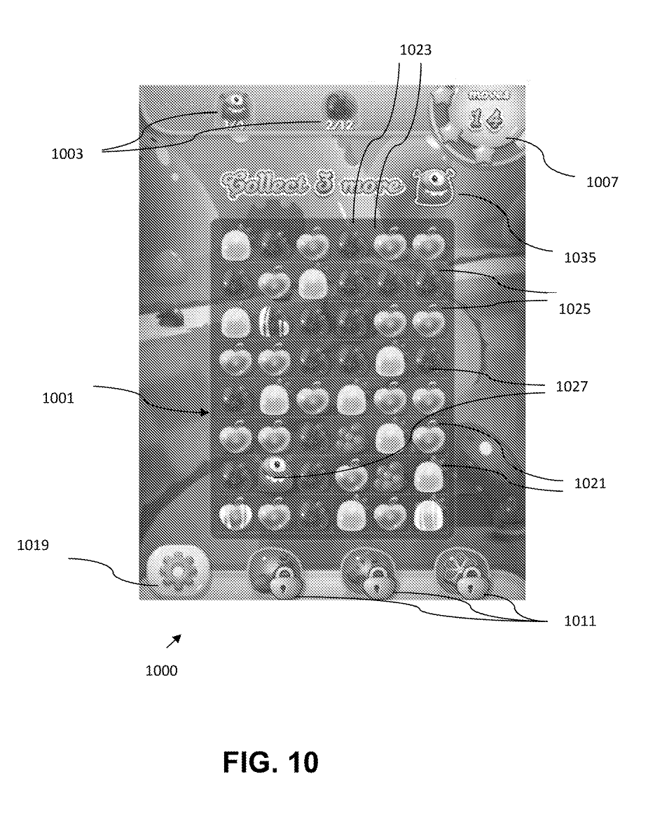

In one embodiment, gameplay is initiated by a user, by selecting a game level icon 201 when the game is in game map mode and the game moves into a game board mode. One embodiment of a game level 1000 that is displayed in the game board mode is shown in FIG. 10. In the embodiment shown in FIG. 10, the display of the game level 1000 comprises a game board 1001, game target indicators or counters 1003, a moves tracker 1007, booster icons 1011, and a game settings icon 1019. The game board 1001 is the area shown on the game level 1000 where the user can select game elements 1027 and initiate selections or movements in an attempt to complete the game level 1000. In the embodiment of FIG. 10, the game level 1000 also includes a gameplay instruction 1035, which may be temporarily displayed either at the commencement of the game level 1000 or other times during gameplay.

As shown in FIG. 10, the game board 1001 is defined by a grid having a plurality of rows 1021, a plurality of columns 1023, and a plurality of cells 1025 defined within the plurality of rows 1021 and the plurality of columns 1023. Game elements 1027 are displayed within at least a portion of the plurality of cells 1025. Additionally, as shown, the game board 1001 may have a semi-opaque appearance. In other embodiments, the game board 1001 may take on other visual appearances, such as, for example, a thematic background appearance that corresponds with a particular game map. In the embodiment shown in FIG. 10, the game board 1001 is formed by 8 rows 1021 by 8 columns 1023 forming cells 1025 within the gridlines. In other embodiments, game boards of the present disclosure may have various shapes and sizes. Accordingly, a game board may have a different number of rows and columns than 8×8, which provides a different configuration. In embodiments, the cells formed by the rows and columns are not continuous with respect to a row or a column or the cells are otherwise discontiguous. Therefore, each game level's game board may have a different size, shape, features, game elements, and game targets and each game board may have features that differentiate one game board from another.

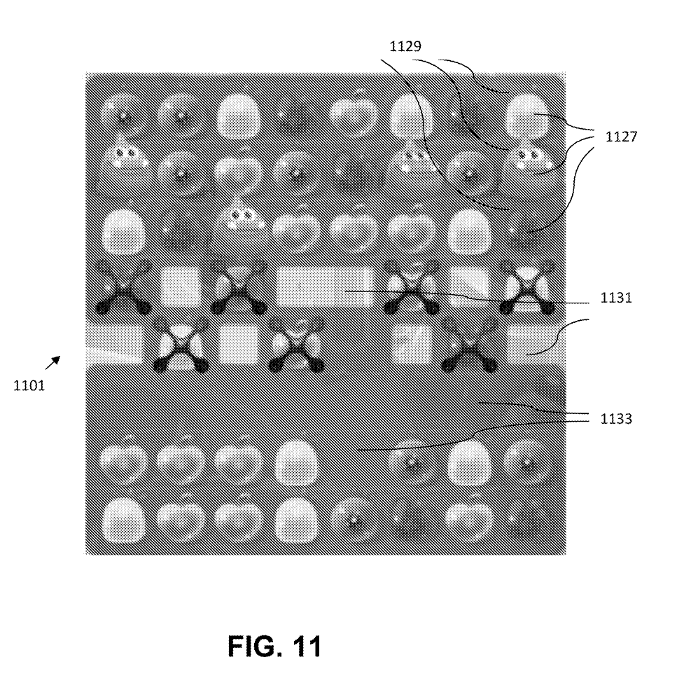

FIG. 11 shows a game board 1101 where certain cells of the game board are not continuous. As shown in the embodiment of FIG. 11, the columns and rows are not continuous and game elements 1127 are shown as being absent from some of the cells of the grid of the game board 1101. Null cells 1131 may be a single cell or more than one cell in shape that do not have a game element 1127 within the null cell 1131. In addition, null cells 1131 may also prevent the user from making a selection that includes a null cell 1131. Further, empty cells 1133 may be present on the game board 1101. Empty cells 1133 are such that they lack a game element 1127. This may be based on a setting of the game board 1101 initially, or as game elements 1127 are cleared or eliminated from the game board 1101 during gameplay. Empty cells 1133 may or may not be replaced with game elements 1127. In one embodiment, an empty cells 1133 is filled by a game element 1127 that was in a cell in the same column as the empty cell 1133, according to a falling downward action with regard to a column. In addition, an empty cell 1133 may allow a user to make a selection that includes an empty cell 1133. In other embodiments, an empty cell 1133 and a null cell 1131 may have the same or similar attributes.

Referring back to the embodiment of FIG. 10, game target indicators 1003 are displayed as counters on the top of the screen that display the different variations of game elements that a user must collect in order to complete the game level 1000. Each of the game target indicators 1003 display a different target game element, which is a particular game element 1027 that a user may be required to collect as part of the gameplay. Collection of game elements is made according to the matching game elements included in a proper selection on the game board 1001. The amount and types of game elements required to complete each game level are displayed by the game target indicators 1003. A target indicator 1003 may also display a number that provides a user a visual cue regarding how many of a particular game element the user must collect in order to complete the game level 1000. The number may be represented as a cumulative target score out of a goal for the game level 1000. The cumulative target score is the sum of each target score for each move or selection made by a player. A moves tracker 1007 displays a number of selections or moves, that a user has remaining for gameplay. In the embodiment of FIG. 10, the moves tracker 1007 is displayed in the top right corner of the display screen and displays the number of moves the user can make in order to complete the game level 1000. The moves tracker 1007 is incremented and tracks the user's remaining moves or selections after each move or selection made by the user.

Also shown in FIG. 10, is a gameplay instruction 1035 that may be displayed to provide a suggestion to a user for a particular game target to collect during gameplay. Further, booster icons 1011 are also shown and may provide a user the ability to use booster items during gameplay. These boosters items are explained in more detail below. As shown in FIG. 10, the booster icons 1011 may be displayed as being locked, with the display of a padlock over the icon 1011, and prevent a user from using booster items until the user has met a certain gameplay parameter. That parameter may include completing game levels, collecting an amount game elements, providing in-game currency to purchase a booster, a combination of these or other conditions.

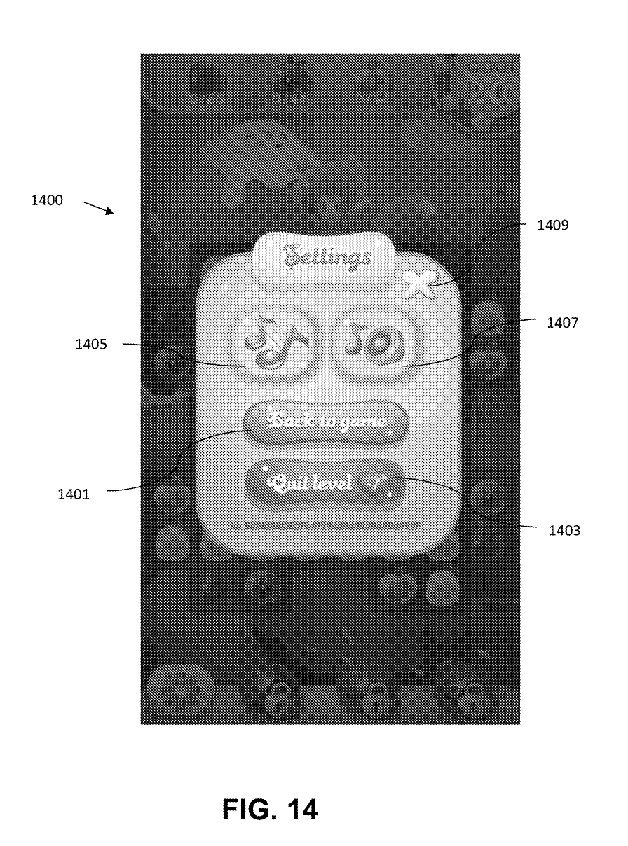

In addition, the game settings icon 1019 is similar to the game setting icon 219 displayed when the game is in the game map mode. An embodiment of a screen presenting a settings menu 1400 that is displayed when a user activates the game settings icon 1019 is shown in FIG. 14. The settings menu 1400 may have a back to game icon 1401, a quit level icon 1403, an in-game music icon 1405, and a special effect sounds icon 1407. The back to game icon 1401 allows a user to effect changes to game settings and then continue with the current game level. The quit level icon 1403 allows a user to choose to quit the current game level. In the embodiment shown in FIG. 14, activation of the quit level icon 1403 costs the user one life point. The in-game music icon 1405 allows a user to turn on or turn off in-game music and a special effect sounds icon 1407 allows a user to turn on or turn off special sound effects that are played during gameplay. In addition, an exit icon 1409 may also be presented that closes the settings menu without recording any changes made and allows a user to return to the game level when activated.

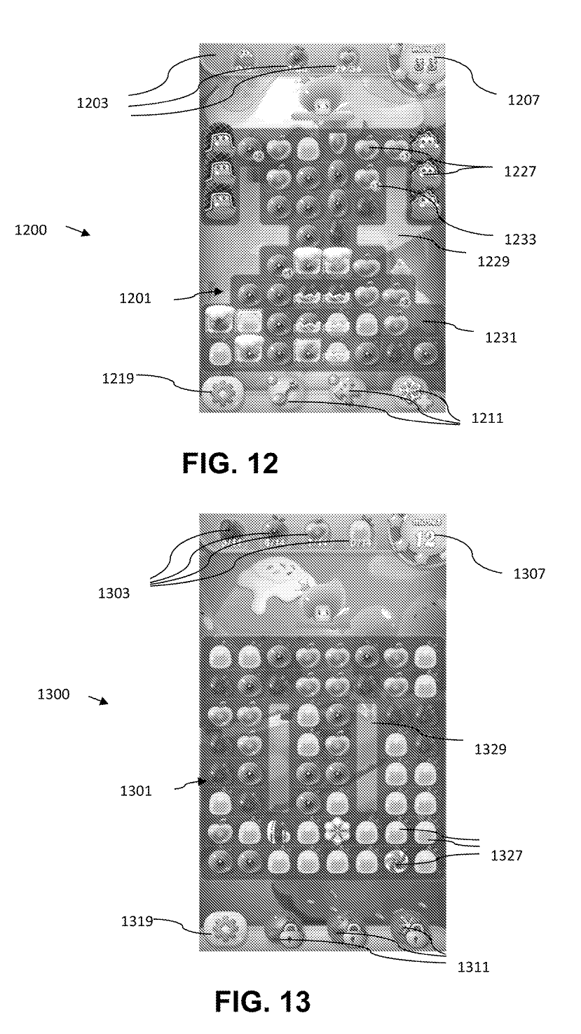

Further embodiments of game levels of the game are shown in FIGS. 12 and 13. As shown in FIGS. 12 and 13, the display of the game levels 1200 and 1300 comprises game boards 1201 and 1301, game elements 1227 and 1327, game target indicators 1203 and 1303, moves trackers 1207 and 1307, booster icons 1211 and 1311, and game settings icons 1219 and 1319, respectively. The game boards 1201 and 1301 each comprise a plurality of null cells 1229 and 1329 that may prevent a user from making a selection that includes one of the null cells 1229 and 1329, respectively. Game board 1201 also comprises empty cell 1231 which may or may be able to be part of a proper selection by a user and may or may not be replaced with a game element 1227 upon a user making a selection. The game board 1201 displays three target indicators 1203 that match game elements 1227 that are currently shown on the game board 1201 or that may be presented after other game elements are removed based on the selection process by the user. Similarly, game board 1301 displays four target indicators 1303. Booster icons 1311 are similar to the booster icons 1011 shown in FIG. 10, however, booster icons 1211 are shown in the active state such that a user is able to employ the booster items shown by the booster icons 1211. In addition, the booster icons 1211 may display a numerical indication of how many of each booster item a user has for gameplay. Plus game element 1233 shown in FIG. 12 is a type of game element that will increase a target score when the user collects or includes the plus game element 1233 within a proper selection. As shown in FIG. 12, since the plus game element 1233 shows a “+1”, the plus game element 1233 will count as one additional target score when it is part of a selection. For example, eliminating or clearing a “+1” standard game element will be counted as collecting 2 standard game elements of the same type. In one embodiment, a random standard game element will become a plus game element after three moves by a user. In another embodiment, the affected standard game element will be a plus game element for a single turn. Moves trackers 1207 and 1307, and game settings icons 1219 and 1319 are the same or similar to the similarly named components shown in FIG. 10.

In one embodiment, as part of gameplay, the user may be given a limited number of selections or moves in order to collect a predetermined number of game elements shown in the target indicators. In one embodiment, the limited number of selections is shown in a moves tracker that is displayed with a game board on a screen of the display device. As a user makes a selection, the number of remaining selections or moves shown in the moves tracker may be incremented downward. In another embodiment, the number shown in the moves tracker may be incremented upward. Additionally, in one embodiment, the number of selections allowed for a game level may be the same for all game levels or different depending on a particular game level. Additionally, this number may be displayed in the moves tracker or it may not be displayed until the user approaches a predetermined range of selections remaining.

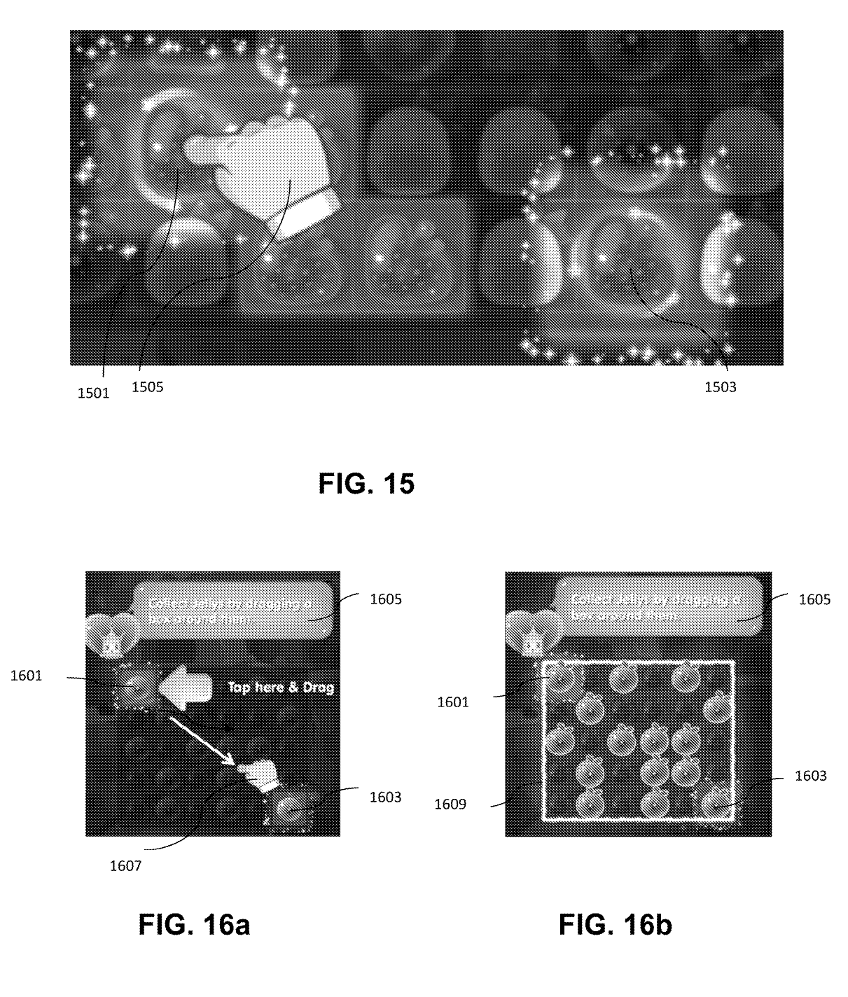

During gameplay, in one embodiment, a goal for the user is to collect a predetermined number of game elements by making selections on a game board. With reference to FIG. 15, a user may make a selection that comprises a first game element 1501 and at least one second game element 1503 of a plurality of game elements displayed on a game board. The selection is made by the user via an input device that may display a pointer 1505. In embodiments, movement of the pointer 1505 may correspond to an input made via computer mouse or an input made via a touchscreen. In order for the selection to result in the collection of game elements, an appearance of the first game element 1501 matches an appearance of the at least one second game element 1503.

As shown in FIGS. 16a and 16b, which is a screen that may be displayed as an instruction for the user demonstrate the selection process, a user may be initiate the selection by touching or contacting the location of a first game element 1601 via the pointer 1607 and then dragging a straight line, or substantially straight line, to the location of at least one second game element 1603 of a plurality of game elements displayed on a game board. In one embodiment, a straight line arrow may be drawn to provide the user with a visual cue of the selection. One the user has touched the location of at least one second game element 1603, a selection box 1609 may be drawn to show the user the game elements that are within the selection. The selection box 1609 is shown as a rectangular box, however the selection box may take on any shape that is appropriate for the game. In one embodiment, all game elements that match the first game element 1601 may be highlighted or otherwise emphasized so that the user is shown all game elements that are to be collected by the selection. In embodiments, the text box 1605 may be displayed to provide the user with instructions to make a selection. In embodiments, the text box 1605 only appears in the first move a user makes during gameplay.

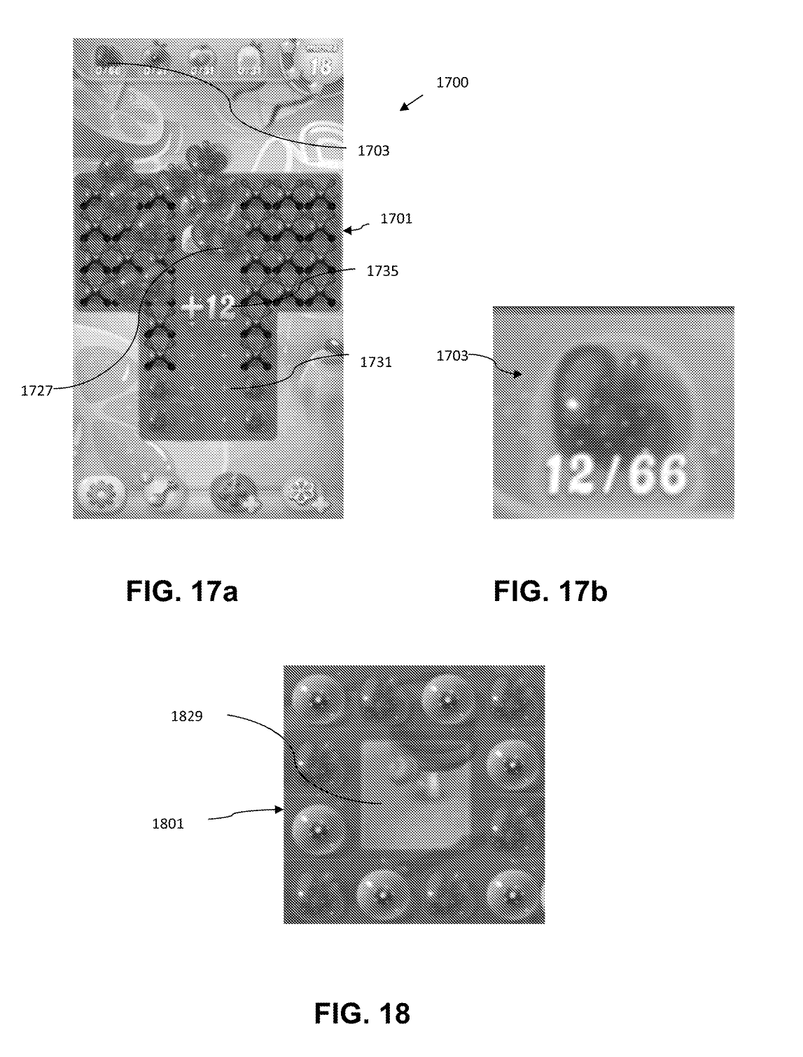

FIGS. 17a and 17b demonstrate screens that are shown as game elements are collected based on a proper selection made by the user. After the selection box is drawn, a plurality of game elements that has an appearance that matches the appearance of the first game element and is located within the selection, is collected. As seen in FIG. 17a, the screen 1700 provides an animation that may be displayed whereby the game elements 1727 that match target indicator 1703 and where within the selection are cleared or eliminated from the game board 1701 and appear to float away. In the embodiment shown in FIG. 17b, a text display may appear to show the user the number of game elements that were collected, which may be a target score, in the selection. In FIG. 17a the number “+12” is displayed indicating to the user that twelve game elements were collected. The number of game elements that are collected are shown in the appropriate target indicator 1703 is incremented accordingly, as seen in FIG. 17b. In the embodiment shown in FIG. 17a, only the game elements that match the first game element and are in the selection box are cleared from the game board 1701.

Once the game elements that were in the selection box are cleared from the game board, the existing game elements that are still shown on the game board 1701 may appear to fall downward (toward the booster item icons) along the columns of the game board 1701, till they either are at the bottommost cell of a column of the game board or they are stopped in a cell of a column of the game board by an existing game element. In one embodiment, new game elements may appear to fall from the top of the game board to fill in any empty cells 1731 that resulted from the selection. In other embodiments, the empty cells 1731 may be replaced randomly with new game elements.

Additionally, a user may be required to make a proper or allowable selection before game elements are collected. In one embodiment, upon determining that the selection is not a proper selection, a notice may be displayed that the selection is not a proper selection. The different allowable or proper selections may be:
selection of a rectangular or square box with two game elements on the opposite corners;
selection of a vertical line with two game elements on the extremes of the line; and
selection of a horizontal line with two game elements on the extremes of the line.

Accordingly, a proper selection may be defined as one of: a rectangular box of cells comprising the first game element and the at least one second game element at opposite corners of the rectangular box, a column of cells comprising the first game element and the at least one second game element at opposite ends of the column of cells, and a row of cells comprising the first game element and the at least one second game element at opposite ends of the row of cells. Further, in one embodiment, if a user tries to make a selection box which includes an obstacle, such as a blocker game element, a null cell, or an empty cell, the selection will not be allowed and the user will need to try to make another selection on the game board. In the example shown in FIG. 18, if the user wants to drag a selection box in a 4 cell by 4 cell square 1801, but a null space 1829 appears in the center, the game will not allow the user to drag and complete the selection box.

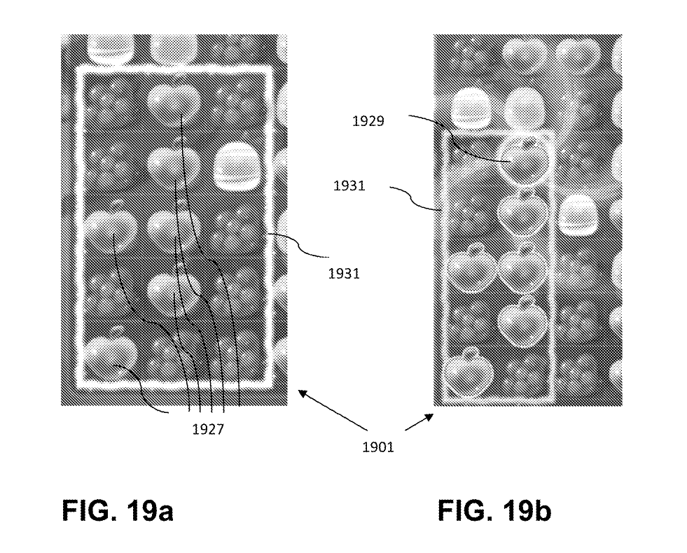

In various embodiments, the visual appearance of a selection box may change once it is determined that the user has made a proper selection. For example, the selection box may take on a first appearance while the selection box is being drawn and the selection box may take on a second appearance once it is determined that the selection box comprises a proper selection. For example, once a proper or allowable selection box has been made, the border of the selection box may provide an indication that the selection is proper. In one embodiment, once an allowable selection box has been made in the dragging process, the border of the selection box may become green or take on a sparking appearance as a visual cue to the user. As shown in FIGS. 19a and 19b, once the user completes a proper selection, all game elements 1927 within the selection box 1931 that match an appearance of the first game element that was touched or contacted to start the selection box will be collected and cleared from the game board 1901. Additionally, as shown in FIG. 19b, if a special game element would be created as a result of this selection, a translucent animation may appear on the game element 1929 that is at an ending point of the selection box 1931 when the selection box is drawn and the animation may indicate the type of special game element that is being created. In another embodiment, the selection box may have an automatic redraw feature that allows the selection box to be redrawn as a proper selection even if the user's initial selection would not have been allowed.

In one embodiment, a common goal of the game is to collect an amount of game elements that correspond to the game elements shown in a target indicator, which may be called target game elements, before running out of moves. Accordingly, a number of game elements collected in a single move or selection may be called a target score. In addition, a total score may be given for each game level. In one embodiment, the total score may be based on points that are accumulated according to the number of game elements collected, types of game elements, such as special game elements, or booster items used during gameplay on a game level, the number of moves remaining when the number of game elements shown by a target indicator is reached. Furthermore, as a user is able to collect more game elements in one move or selection, the number of points awarded may be increased. In one embodiment, for each standard game element collected, 1,000 points are added to the Player's total score. In another embodiment, a user may only have a limited amount of time to make selections or obtain a predetermined number of point, such that calculating the total score comprises calculating the total score over a predetermined time period.

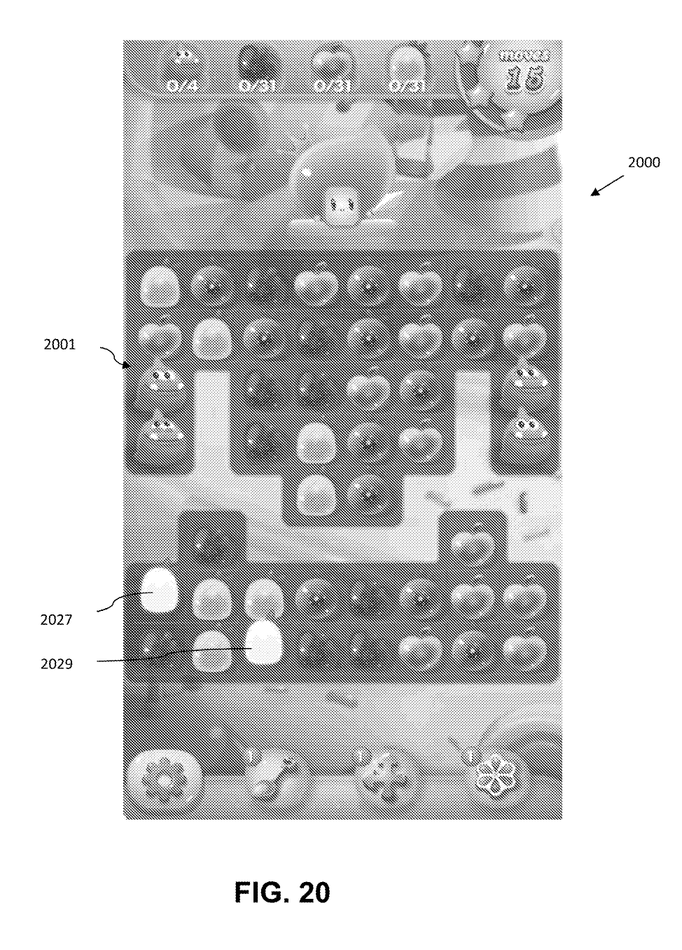

In one embodiment, where a user hasn't made a selection for a predetermined period of time or the game is otherwise inactive for a predetermined period of time, a visual cue may be made to the user to instruct the user about a potentially successful selection, which is also referred to as a “hint”. As shown in the screen 2000 of FIG. 20, the hint is displayed by making game elements 2027, 2029 shown on game board 2001 change color and/or shape. For example, a first game element 2027 and a second game element 2029 that matches the first game element 2027, which are included in a potentially successful selection, are shown in a bright color and appear to be bouncing up and down. If the user does not make a selection according to hint provided within a predetermined period of time, then the game may display the same hint again or it may display a different hint, involving different game elements.

Various types of game elements are disclosed herein as part of the game. Game elements are selectable elements and/or in-game obstacles that appear on a game board of a game level. In one embodiment, types of game elements may include standard game elements, special game elements, monster game elements, and blocker game elements.

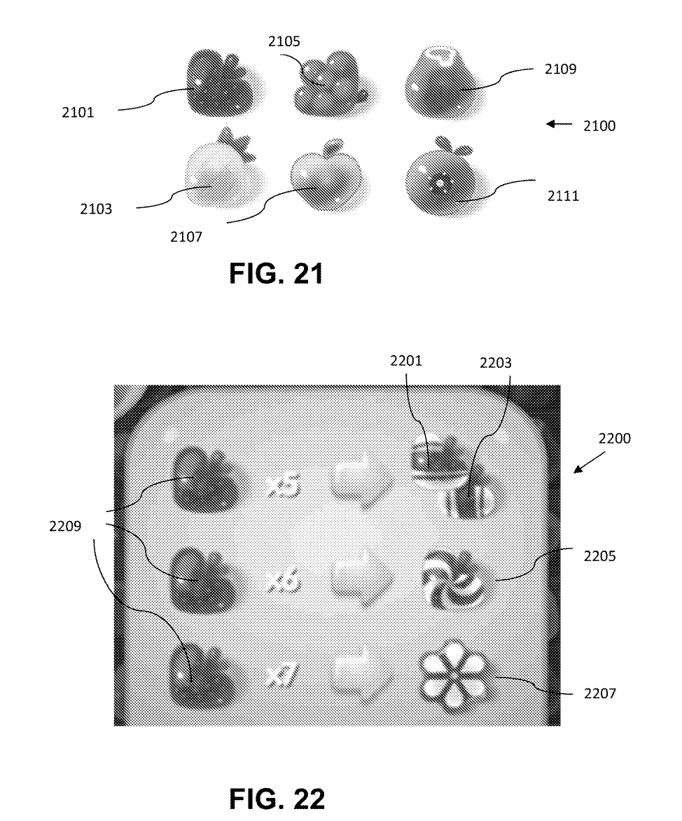

Non-limiting embodiments of the various types of game elements are shown and described with regard to FIGS. 21-42. FIG. 21 shows a plurality of standard game elements 2100. Each of the standard game elements has a unique visual appearance, for example the color and shape of each standard game element may be unique. In one embodiment, the standard game elements have shiny, semi-translucent appearances that imitate the appearance of jelly. In the embodiment shown in FIG. 21, the standard game elements have appearances corresponding to fruit-type exaggerated figures. The six standard game elements 2100 shown in FIG. 21 are:
Red jelly in the shape of a strawberry 2101
Purple jelly in the shape of a grape 2105
Brown jelly in the shape of a coconut 2109
Yellow jelly in the shape of a pineapple 2103
Green jelly in the shape of a apple 2107
Blue jelly in the shape of a blueberry 2111

FIG. 22 provides a screen display 2200, which may be part of a game instruction provided to a user that explains the process of creating special game elements during game play. Special game elements are elements displayed on a game board in a game level that have special attributes and behaviors. In one embodiment, the collection of five or more standard game elements 2209 of the same appearance will reward the Player with special game element. In one embodiment, special game elements comprise a horizontally striped game element 2201 or a vertically striped game element 2203, a swirl game element 2205, and a blossom game element 2207. As shown in FIG. 22, a horizontally striped game element 2201 or a vertically striped game element 2203 may be provided by collecting five standard game elements 2209 of the same appearance. In addition, a swirl game element 2205 may be provided by collecting six standard game elements 2209 of the same appearance. Further, a blossom game element 2207 may be provided by collecting seven or more standard game elements 2209 of the same appearance. Special game elements may have various beneficial properties and can be used to facilitate passing a level.

In one embodiment, during a selection as described above, a special game element will generate in the last cell of the selection process. In one embodiment, for a horizontally or a vertically striped game element 2201, 2203, selection of a horizontal line or box will generate a vertically striped game element 2203, and selection of a vertical line or box will generate a horizontally game element 2201. Further, if the selection is rectangular-shaped, then the game may randomly choose between a horizontally and vertically striped game element 2201, 2203.

Each special game element has its own unique burst effect, which can benefit and help the user to achieve the goals of a game level by eliminating multiple game elements with a single move or selection. The game elements that are eliminated by the special elements may be any type or combinations of types of game elements, including standard game elements, monster game elements, or other special game elements. In one embodiment, there may be four different ways to activate or trigger a special game element received by collecting more than five same standard game elements:
A special game element will activate if it is the same color as the standard game elements being collected in the selection box;
A special game element can be used as beginning or ending point of the selection box during the dragging process, which will activate the special game element's effect;
A special game element will be activated if it is hit by another special game element's burst effect; and
Certain types of other game elements, such as monster game elements, can also activate a special game element by eliminating it.

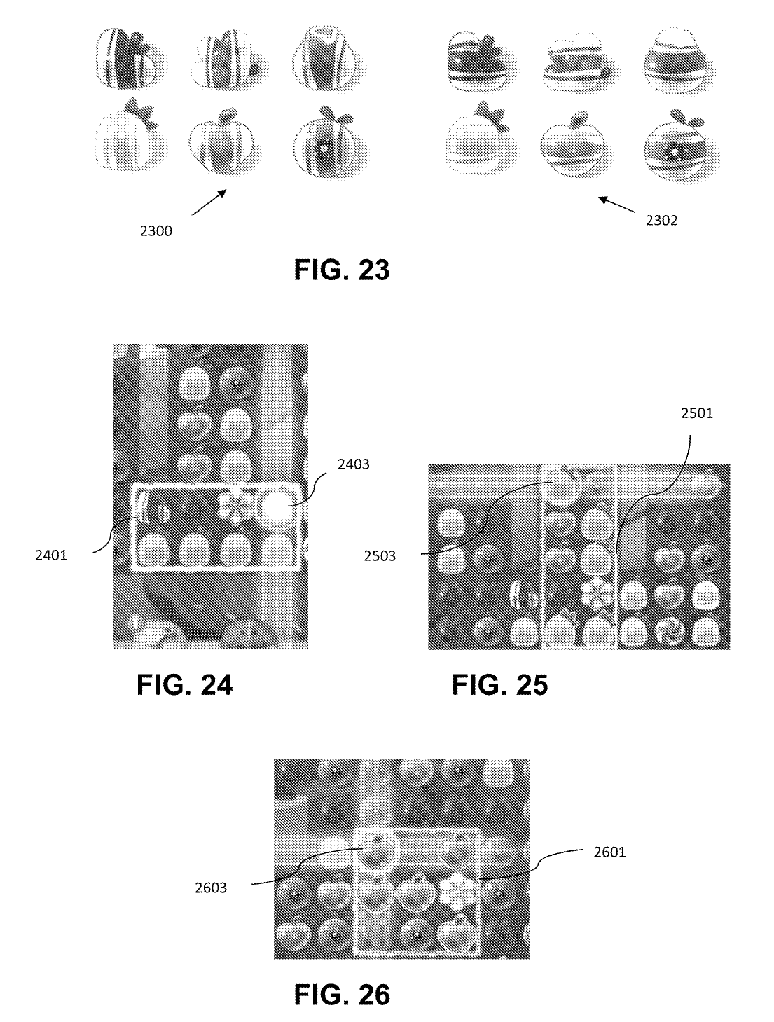

The embodiments shown in FIG. 23 illustrate the appearance of horizontally striped game elements 2302 and vertically striped game elements 2300. Horizontally and vertically striped game elements 2302, 2300 may have the same shape as a standard game element from which it was generated and each one has a large vertical or horizontal line, respectively, of the same color as the standard game element to which is corresponds. In the embodiments shown in FIG. 23, the shape of horizontally or vertically striped game elements 2302, 2300 and the color of the stripe are the same as the standard game elements which were selected to generate the horizontally or vertically striped game element, respectively.

As shown in FIG. 24, five matching standard game elements are shown in the selection box 2401 and a vertically striped game element will be generated in cell 2403 as the selection box is horizontal. As shown in FIG. 25, five matching standard game elements are shown in the selection box 2501 and a horizontally striped game element will be generated in cell 2503 as the selection box is vertical. Further, as shown in FIG. 26, five matching standard game elements are shown in the selection box 2501 and either a horizontally or vertically striped game element will be generated in cell 2603 as the selection box is rectangular.

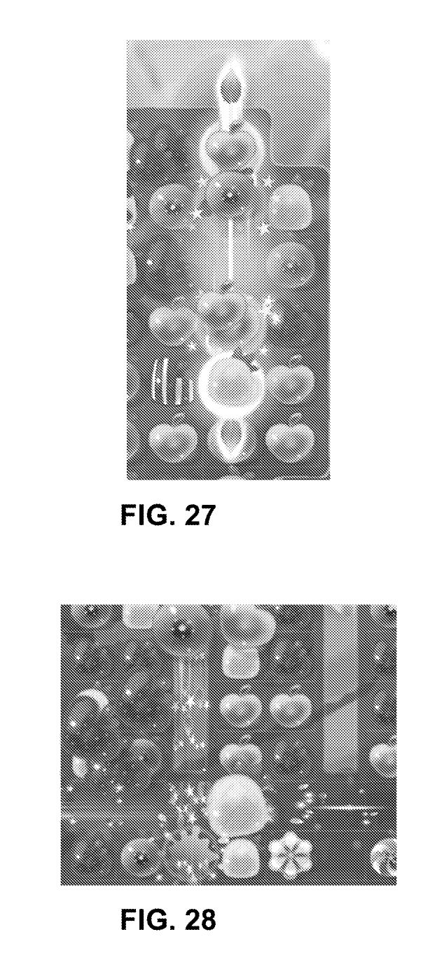

In one embodiment, horizontally or vertically striped game elements are configured to produce a line burst effect that removes an entire row or column, respectively. When a horizontally or vertically striped game element is activated, an animation shoots out of the horizontally or vertically striped game element following the row or column that it is removing. The animation looks as if the horizontally or vertically striped game element is being stretched out and shoots out two parts in opposite directions simultaneously with a sparkle effect. In one embodiment, for all game elements that are eliminated by the effect, the number of the corresponding standard game elements will count towards the game level's collection target, if applicable. FIG. 27 is a screen display of the animation shown when a vertically striped game element is activated and FIG. 28 is a screen display of the animation shown when a horizontally striped game element is activated.

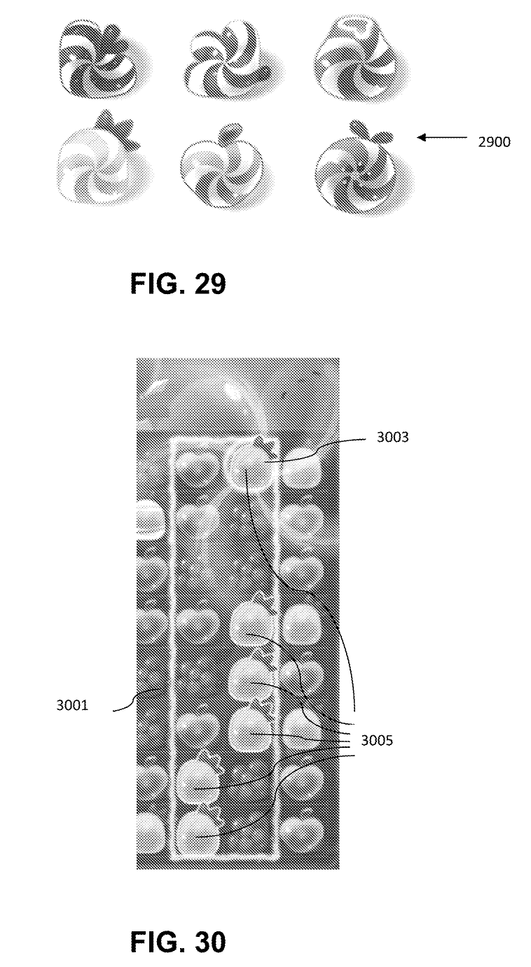

The embodiments shown in FIG. 29 illustrate the appearance of swirl game elements 2900. Swirl game elements 2900 may have the same shape as a standard game element and each one has spiral lines of the same color as the standard game element to which is corresponds. In the embodiments shown in FIG. 29, the shape of the swirl game elements 2900 and the color of the swirl are the same as the standard game elements which were selected to generate the swirl game element. As shown in FIG. 30, six matching standard game elements 3005 are shown in the selection box 3001 and a swirl game element will be generated in cell 3003.

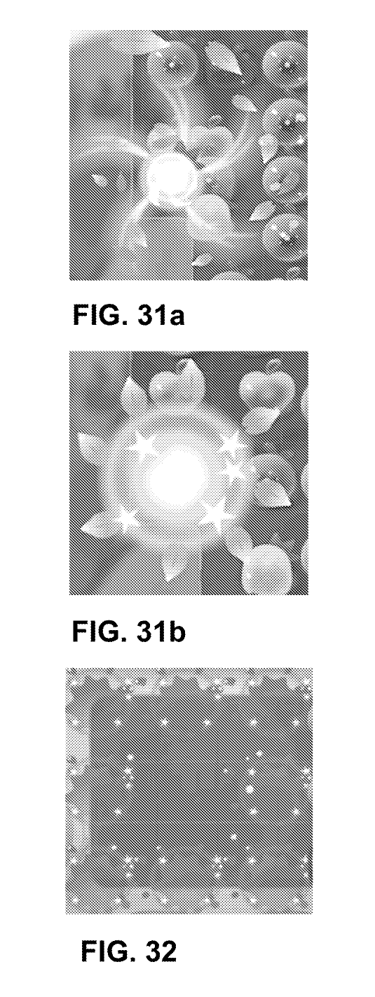

In one embodiment, swirl game elements are configured to produce a burst effect that removes the game elements in an area defined by the cells adjacent the swirl game element. When a swirl game element is activated, an animation shoots out of the swirl game element following the area which it is clearing. The animation looks as if the swirl game element is shrinking and lines are spiraling clockwise into the swirl game element, then exploding in a circular shape with a sparkle effect in the area of adjacent cells. In one embodiment, for all game elements that are eliminated by the effect, the number of the corresponding standard game elements will count towards the game level's collection goal, if applicable. FIGS. 31a-32 are screen displays of the animation shown when a swirl game element is activated.

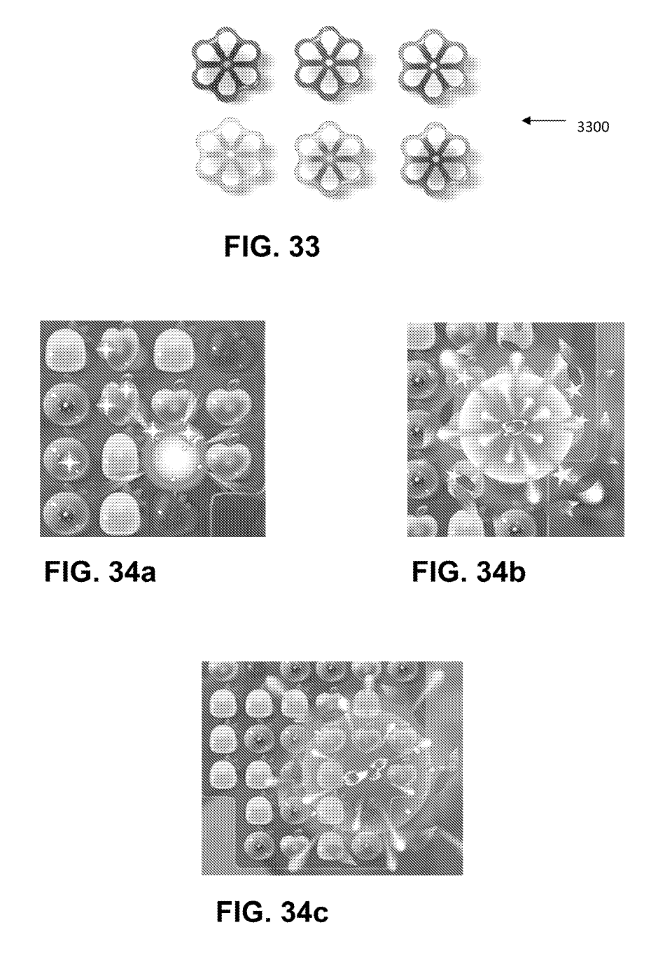

FIG. 33 illustrates the appearance of embodiments of blossom game elements 3300. Blossom game elements 3300 may have a hexagonal body with circular outside edges and the same color as the standard game elements which were selected to generate the blossom game element. In one embodiment, seven or more matching standard game elements must be located in a selection box to generate a blossom game element.

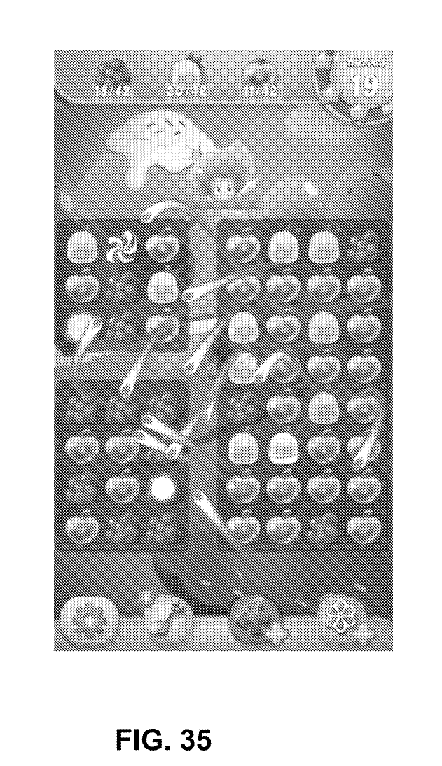

In one embodiment, blossom game elements are configured to produce an effect that eliminates all game elements which have the same color as the blossom game element on an entire game board. When a blossom game element is activated, an animation shoots out of the blossom game element that covers the entire game board. The animation looks as if the blossom game element is being surrounded by a colored halo with sparkle effect, then petals will appear around the halo, which will shoot out as more petals shoot out from the blossom game element and dash to eliminate game elements of the same color as the blossom game element. In one embodiment, for all game elements that are eliminated by the effect, the number of the corresponding standard game elements will count towards the game level's collection goal, if applicable. FIGS. 34a-35 are screen displays of the animation shown when a swirl game element is activated.

In embodiments, the game implements several kinds of game elements as blocker game elements. Blocker game elements may be game elements that act as obstacles for the user when making selection on the game board. Further, different blocker game elements can have different properties. Those properties may include preventing standard game elements from replacing empty cells, for example, based on a vertical falling process to fill empty cells that are on the game board. Blocker game elements may also randomly eliminate standard game elements (which were not part of a selection) after the Player's selection is made. In one embodiment, monster blocker elements, including normal, rocket, boomerang, and waffle monster blocker game elements and ice frosting blocker game elements will not obstruct the Player's selection process, but ice frosting blocker game elements may not be used as beginning or ending point for the selection box. In one embodiment, chain blocker game elements may obstruct the Player's selection process.

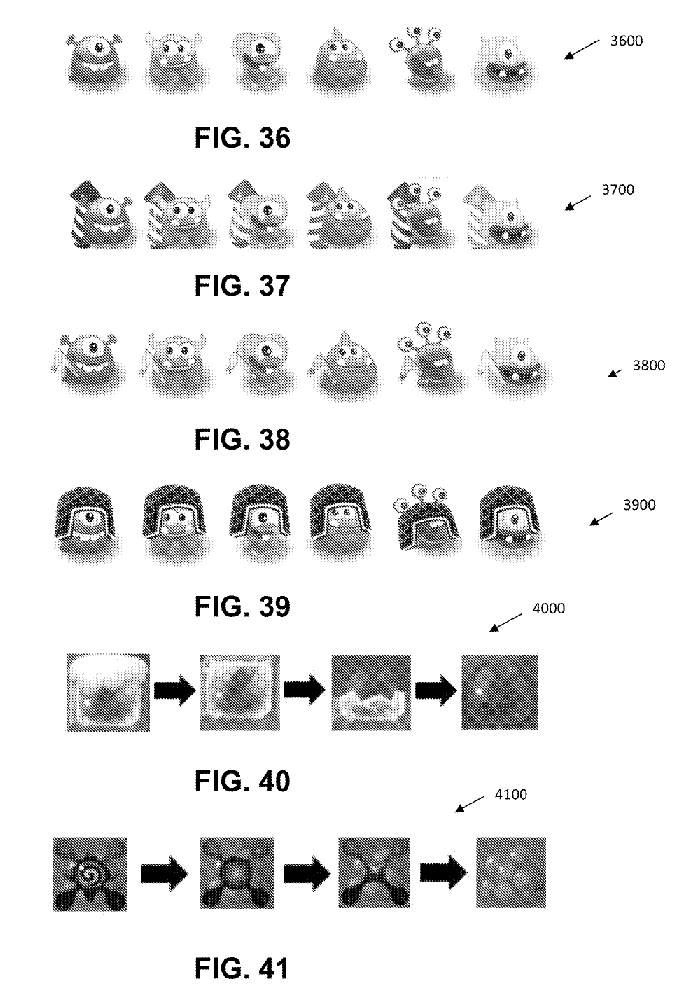

According to non-limiting embodiments, monster blocker game elements may comprise:
Normal Monster game elements 3600 shown in FIG. 36;
Rocket Monster game elements 3700 shown in FIG. 37;
Boomerang Monster game elements 3800 shown in FIG. 38; and
Waffle Monster game elements 3900 shown in FIG. 39.

In one embodiment, a normal monster blocker game element 3600 occupies one cell on a game board and functions as an obstacle that can randomly eliminate an adjacent standard game element that is the same color as the normal monster game element 3600, if the standard game element is in the top, bottom, left, or right of an adjacent cell after a user's move. However, the standard game elements eliminated by the normal monster blocker game element 3600 may not count towards the user's goal for target game elements. In another embodiment, a normal monster blocker game element 3600 may also be able to fall down along a column on a game board to fill empty cells.

In one embodiment, a rocket monster blocker game element 3700 has the same appearance as a normal monster blocker game element 3600, except it holds a rocket and can be animated to randomly fly to and eliminate a standard game element of the same color, including special game elements, in another random cell on the game board after the Player's move. In one embodiment, a rocket monster blocker game element 3700 will target standard game elements first, however, special game elements may be eliminated by the rocket monster blocker game element 3700 and a corresponding burst effect of the special game element will not activate. Further, the standard game elements eliminated by the rocket monster blocker game element 3700 will not count towards the Player's goal for target game elements. In another embodiment, a rocket monster blocker game element 3700 may also be able to fall down along a column on a game board to fill empty cells.

In one embodiment, a boomerang monster blocker game element 3800 has the same appearance as the normal monster blocker game element 3600 except it holds a boomerang and can be animated to throw its boomerang to eliminate a standard game element of the same color, including special game elements, in another cell on the game board after the Player's move. In one embodiment, a boomerang monster blocker game element 3800 will target standard game elements first, however, special game elements may be eliminated by a boomerang monster blocker game element 3800 and a corresponding burst effect of the special game element will not activate. Further, the standard game elements eliminated by a boomerang monster blocker game element 3800 will not count towards the Player's goal for target game elements. In another embodiment, a boomerang monster blocker game element 3800 may also be able to fall down along a column on a game board to fill empty cells.

In one embodiment, a waffle monster blocker game element 3900 has the same appearance as the normal monster blocker game element 3600 except it wears a waffle helmet and has the ability to randomly eliminate an adjacent standard game element and/or special game element of the same color that is in an adjacent cell after the Player's move. In one embodiment, a waffle monster blocker game element 3900 will target standard game elements first, however, special game elements may be eliminated by a waffle monster blocker game element 3900 and a corresponding burst effect of the special game element will not activate. Further; the standard game elements eliminated by a waffle monster blocker game element 3900 will not count towards the Player's goal for target game elements. In another embodiment, a waffle monster blocker game element 3900 may also be able to fall down along a column on a game board to fill empty cells.

In an embodiment, a monster blocker game element may be eliminated by either causing a burst effect to hit the location of the monster blocker game element or to include the monster blocker game element in a selection. Additionally, certain monster blocker game elements may have different characteristics than others. In one embodiment, each time a waffle monster blocker game element 3900 is hit by a burst effect or by is inside the selection box, its waffle helmet will appear as being chipped away and a user must hit or select the waffle monster blocker game element 3900 three times to completely eliminate the waffle monster blocker game element 3900. Further, in one embodiment, a normal monster blocker game element 3600 may be eliminated due to being hit once by a burst effect or being included in a selection box once.

According to one embodiment, there may be three ways the Player can eliminate monster blocker game elements:
By including the monster blocker game element in the selection box with standard game elements of the same color;
Using a burst effect from a special game element to hit the monster blocker game element; and
Using a booster item to eliminate the monster blocker game element.

In addition, blocker game elements may also comprise standard game elements with a modified appearance to show that they are blocker game elements. Such blocker game elements may also have different characteristics. For example, such blocker game elements are shown in FIGS. 40 and 41. In FIG. 40, a standard game element is shown as modified to be a blocker game element, from left to right, as a 3 layer ice frosting blocker game element, a 2 layer ice frosting blocker game element, a 1 layer ice frosting blocker game element, and a corresponding standard game element. In FIG. 41, a standard game element is shown as modified to be a blocker game element, from left to right, as a 3 layer chain blocker game element, a 2 layer chain blocker game element, a 1 layer chain blocker game element, and a corresponding standard game element. In one embodiment, an ice frosting blocker game element and/or a chain blocker game element can have a maximum of three layers and will become a standard game element after all layers are removed.

In one embodiment, a 3 layer, 2 layer, or 1 layer ice frosting blocker game element cannot be selected as the beginning or ending point of the selection box and cannot be moved, but will not otherwise obstruct a selection box. A 3 layer, 2 layer, or 1 layer ice frosting blocker game element may be configured not to fall down along a column on the game board to fill empty cells. In one embodiment, to remove a layer of the ice frosting blocker game element, the Player may:
Include the ice frosting blocker game element in a selection when selecting standard game elements with the same color as the ice frosting blocker game element;
Use a burst effect from a special game element to hit the ice frosting blocker game element; and
Use a booster item to eliminate the ice frosting blocker game element.

In one embodiment, a 3 layer, 2 layer, or 1 layer chain blocker game element cannot be moved and will obstruct a selection box. A 3 layer, 2 layer, or 1 layer chain blocker game element may be configured not to fall down along a column on the game board to fill empty cells. In one embodiment, to remove a layer of the chain blocker game element, the Player may:
Use a burst effect from a special game element to hit the chain blocker game element; and
Using a booster item to eliminate the chain blocker game element.

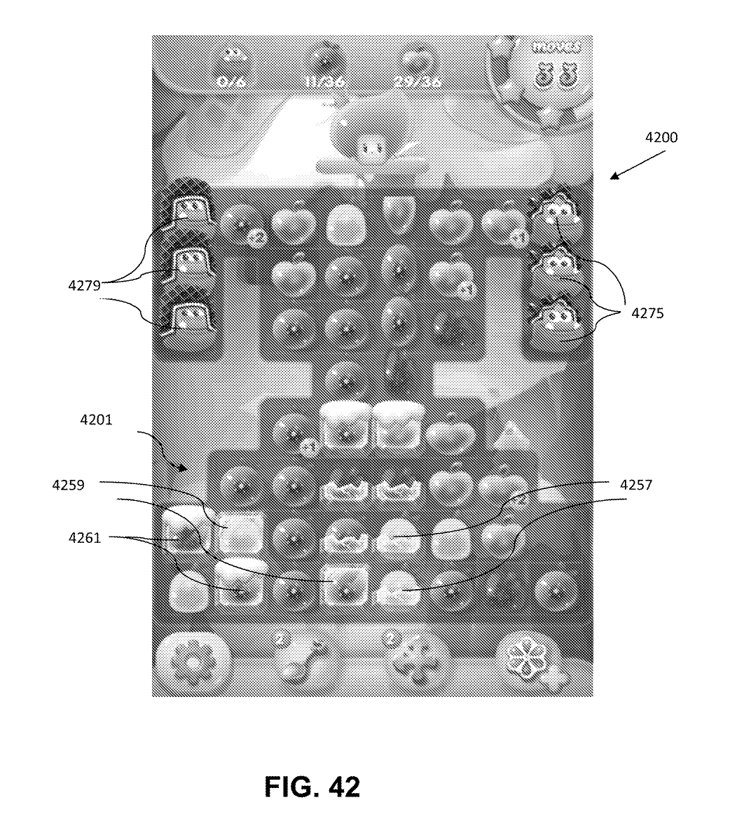

FIG. 42 illustrates game level 4200, the different layers on the game board 4201, and various blocker game elements as described. Waffle monster blocker game elements 4275 and 4279 are shown. Waffle monster blocker game elements 4275 are shown as having the appearance of the waffle being chipped away. 3 layer ice frosting blocker game elements 4261, 2 layer ice frosting blocker game elements 4259, and 1 layer ice frosting blocker game elements 4251 are also shown. During gameplay, the game elements 4251, 4259, 4261, 4275, and 4279, will have characteristics as described above.

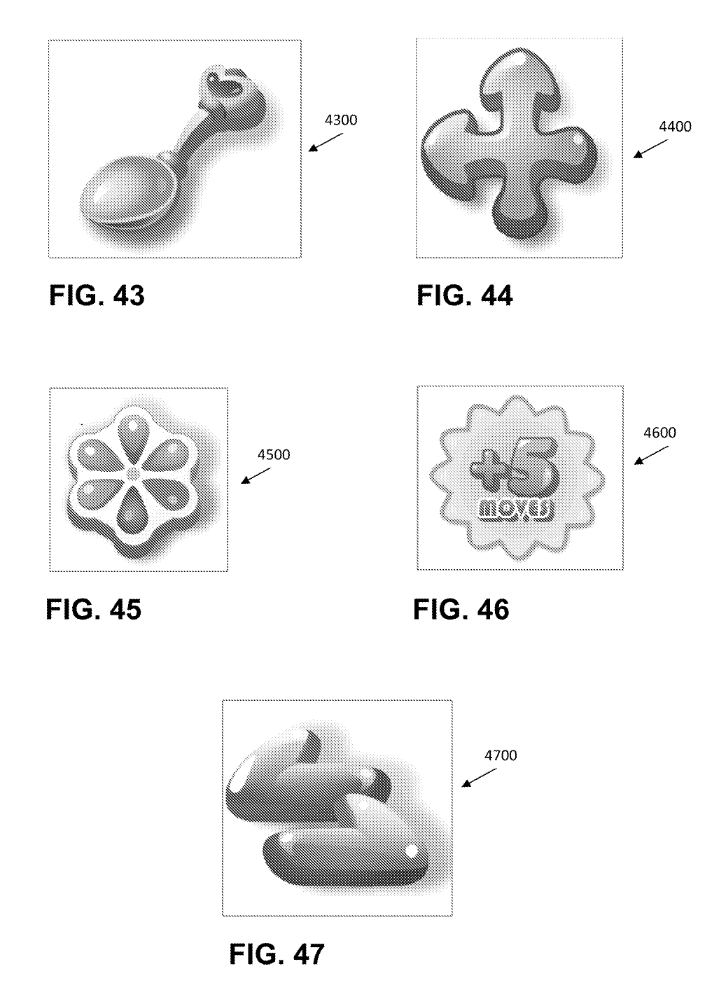

Non-limiting embodiments of booster items are illustrated in FIGS. 43-47. In one embodiment, the game has a selection of booster items that may be available to the Player. These booster items are in-game items that can help the Player by enhancing gameplay and accelerating collection of target game elements. In embodiments, a Player's available list of booster items is shown on the bottom of the screen, as described in FIGS. 10, 12, and 13. A Player may be able to choose when and where to use booster items on a game board within a game level. In one embodiment, booster items can only be used before the Player's move or selection, after all game elements have been moved to fill empty cells, and after all special game elements have been generated on the game board. Using booster items may not count against the Player's available moves, as shown in a moves tracker, in a game level. In one embodiment, a Player may be able to purchase booster items with in-game currency, such as diamonds. In one embodiment, the booster items available to a Player are:
Golden Spoon 4300 shown in FIG. 43;
Directional Cross 4400 shown in FIG. 44;
Rainbow Blossom 4500 shown in FIG. 45;
Plus 5 Moves 4600 shown in FIG. 46; and
Exchange Arrows 4700 shown in FIG. 47.

A golden spoon 4300 is shown as having the appearance of a shiny spoon in gold color. The Player may be able use it anywhere on the game board to remove a standard game element, special game element, a monster blocker game element, or one layer of ice frosting blocker game element or chain blocker game element. If a special game element is removed, its burst effect may be activated immediately. If the removed game element or if a special game element is a target game element of the game level, it will count towards the goal for target game elements. After using, an empty cell that is the result of using the golden spoon may be filled by standard game element from above or adjacent cells, if there is not an obstruction.

A directional cross 4400 is shown as having the appearance of a green cross with horizontal and vertical arrows pointing upward and to one side. The Player can use the directional cross 4400 anywhere on a game board to create a simultaneous horizontal and vertical line burst effects from a selected cell. If a standard game element or special game element is a target of the game level, those game elements cleared by the directional cross 4400 may count towards the goal for target game elements. A game board may adjust for empty cells after the burst effect.

A rainbow blossom 4500 has an appearance like a blossom game element except that each of its petals has a different color. The Player may use the rainbow blossom 4500 on a standard game element, anywhere on the game board, to turn it into a blossom game element of the same color as the standard game element and activates the burst effect of the blossom game element immediately. If a standard game element or special game element is a target of the game level, those game elements cleared by the rainbow blossom 4500 may count towards the goal for target game elements. The game board may adjust for empty cells after the burst effect.

The Plus 5 Moves 4600 booster item has the appearance of a circular callout box with smooth edges and contains the words “+5 moves” in color. Using the Plus 5 Moves 4600 booster item may add 5 more moves to the Player's current available moves shown in a moves tracker. In other embodiments, different increments of moves may be provided by other booster items. For example, the may be a plus 3 moves booster item, or any other number of moves as appropriate.

In one embodiment, the exchange arrows 4700 booster item is a booster that is configured to switch the position of a standard game element or special game element in one cell with another game element at a different position on the game board. In another embodiment, the exchange arrows 4700 booster item may be configured to allow a user to switch any game element in one cell with another game element at a different position on the game board.

In addition to the regular gameplay associated with game levels of the game, a bonus round feature may also be included. When the Player has collected the game elements shown in the target indicator(s) or fulfilled other requirements of the level, if the Player still has moves or selections leftover, the game may enter into bonus round stage. In one embodiment of the bonus round stage, each leftover move will result in a random standard game element on the game board being turned into a blossom special game element and the corresponding burst effect will activate immediately. The game elements collected during this bonus round stage may be added to the Player's target score. Furthermore, this may increase the Player's total score and/or percentage of level completion.

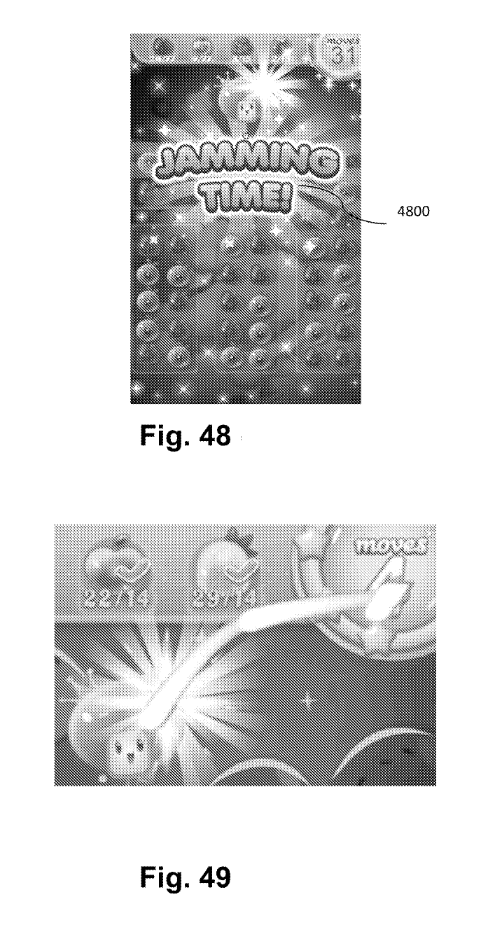

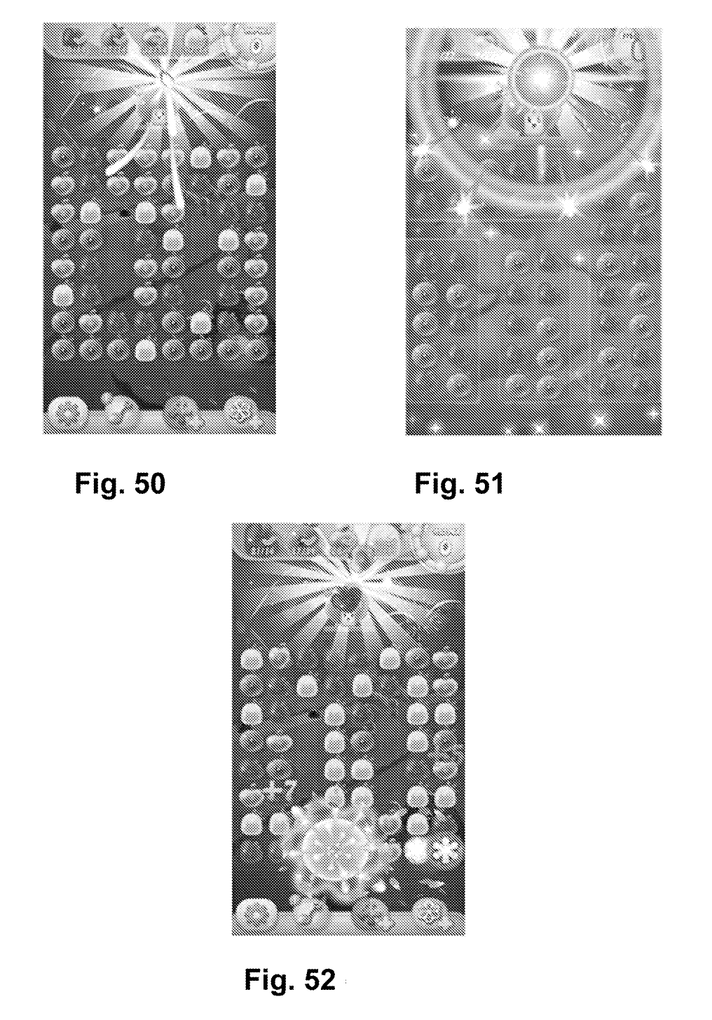

As shown in FIG. 48, the bonus round stage may be displayed with an animation that includes a graphic 4800 of the words “Jamming Time”. The animation that follows is shown in FIGS. 49-52.

Throughout game play, a user may encounter different types of game levels that require the user to fulfill various criteria or accomplish various goals in order to complete different type of game levels. Besides the collection of game elements, the Player may be given different tasks, such as, for example, eliminating monster blocker game elements, collecting musical note game elements, and defeating boss level characters. In one embodiment, there may be four different types of game levels in the game.

In a normal game level a goal may be to collect certain types and amounts of standard game elements before running out of moves or selections. Points may be accumulated through standard game elements that are collected and special game elements that are used during the game level. In one embodiment, with regard to a normal game level, the more standard game elements collected in one move, the more points that are awarded to a user. An embodiment of a normal game level is shown in FIG. 13. Accordingly, the target indicators 1303 in the game level 1300 correspond to standard game elements that are displayed in the cells of the game board 1301.

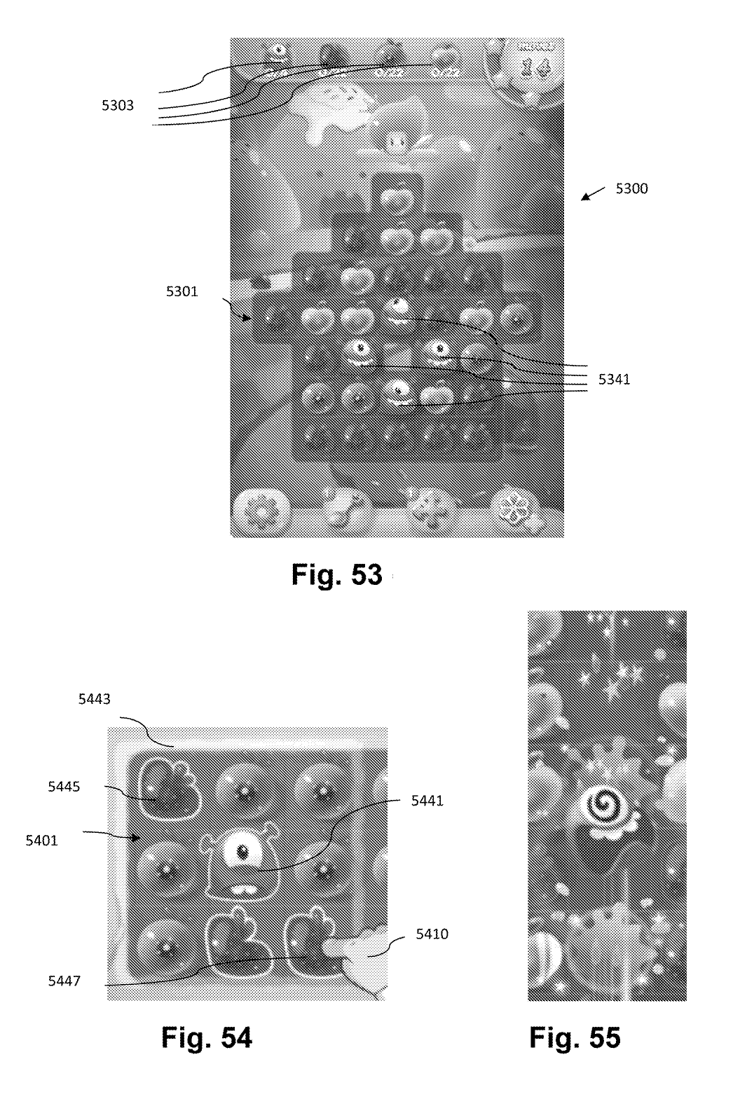

In a monster game level, a Player may be required to eliminate or collect monster game blocker elements in addition to collecting standard game elements, which may be more difficult to accomplish within a give number of moves. An embodiment of a monster game level is shown in FIG. 53. In the game level 5300, a monster blocker game element is shown in the target indicators 5303. Normal monster blocker game elements 5341 occupy cells on the game board 5301 and a user is tasked with collecting or eliminating the normal monster blocker game elements 5341 from the game board 5301. The normal monster blocker game elements 5341 may have any or all characteristics as described above. Accordingly, as shown in FIG. 54, a normal monster blocker game element 5441 may be eliminated or cleared from game board 5401 when a user makes a selection by selecting a first game element 5445 with pointer 5410 and then selecting a second game element 5447 causing a selection box 5443 to be drawn around the first and second game elements 5445, 5447, along with the normal monster blocker game element 5441. FIG. 55 illustrates the animation associated with eliminating a normal monster blocker game element from a game board.

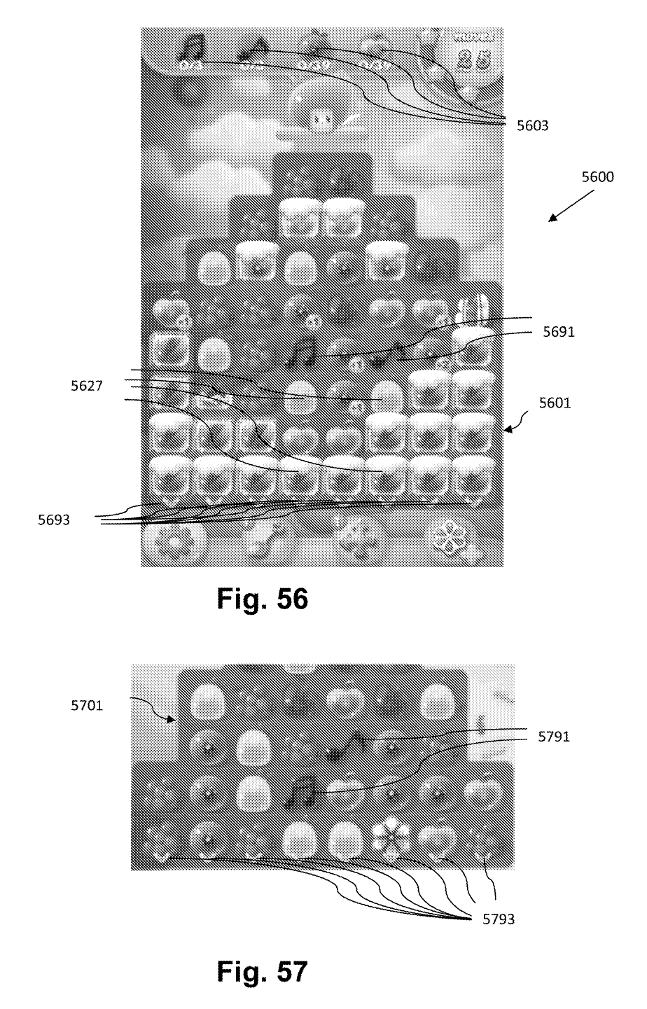

An embodiment of a musical note game level is shown in FIG. 56. In a musical notes level, a Player may be tasked with collecting musical note game elements in addition to standard game elements. In one embodiment, even though there may be several different types of musical note game elements, only one musical note game element of the each type may appear on the game board at one time. As shown in the embodiment of FIG. 56, the target indicators 5603 include musical note game elements which correspond to musical note game elements 5691 on the game board 5601. In one embodiment, the Player is able to collect the musical note game elements 5691 by eliminating game elements 5627, which may be standard game element or other types of game elements as shown in FIG. 56, within the same column that are below the musical note game elements 5691, so that the musical note game element 5691 can drop down on the game board once the game elements 5627 in the same column are removed. Ultimately, the musical note game elements 5691 will drop down through the green downward directional arrows 5693 to be collected and counted towards the goals displayed by the target indicators 5603. FIG. 57 provides a close up view of another musical note game level, where musical note game elements 5791 are displayed on game board 5701 having green downward directional arrows 5793.

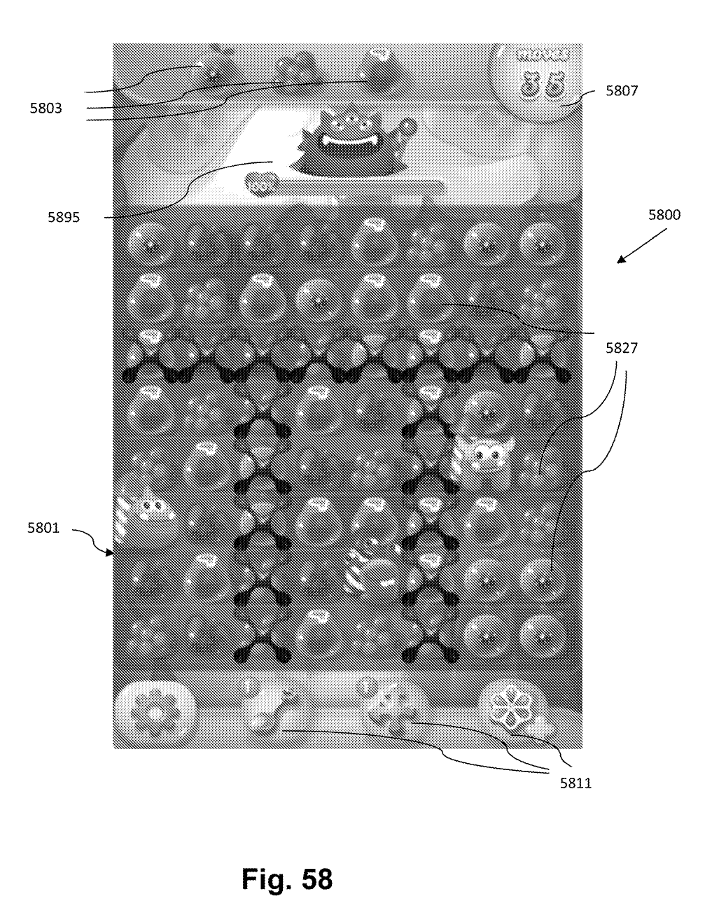

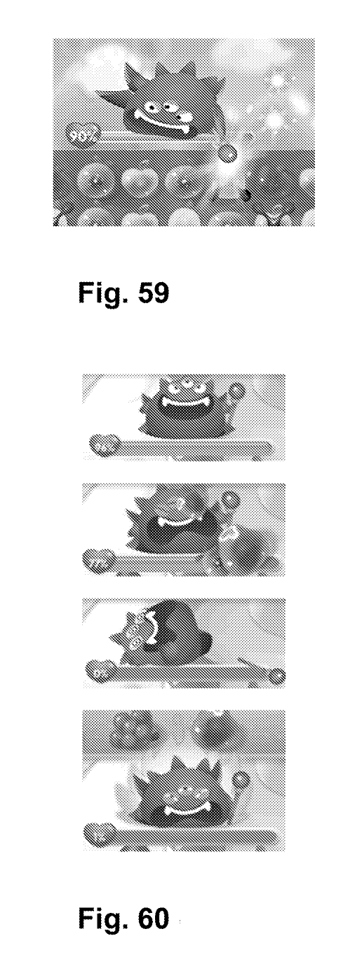

An embodiment of a boss game level is shown in FIG. 58. In a boss game level, a Player may be required to collect the different standard game elements displayed in the target indicators 5803 within the number of moves shown in the moves tracker 5807 in order to complete the boss level. By collecting the game elements 5827 displayed in the target indicators 5803, the collection of game elements is shown as attacking the boss character 5895. The boss character is defeated, and a boss level is completed, when the life meter of the boss character reaches 0% from 100%. According to the embodiment shown in FIG. 58, each time the game elements displayed in the target indicators 5803 are collected according to selections made by the user on game board 5801, a percentage of the life meter of the boss character is reduced. The percentage of that the life meter is reduced may depend on the number of matching game elements in a selection. In one embodiment, the boss character may release an effect that unfavorably affects the Player after every third selection made by the Player. FIGS. 59 and 60 display various animations that are presented during a boss game level. The animations may be different when the boss character is being attacked and when its life point is at different percentages, such that it will have different facial expressions to increase the Player's gaming experience.

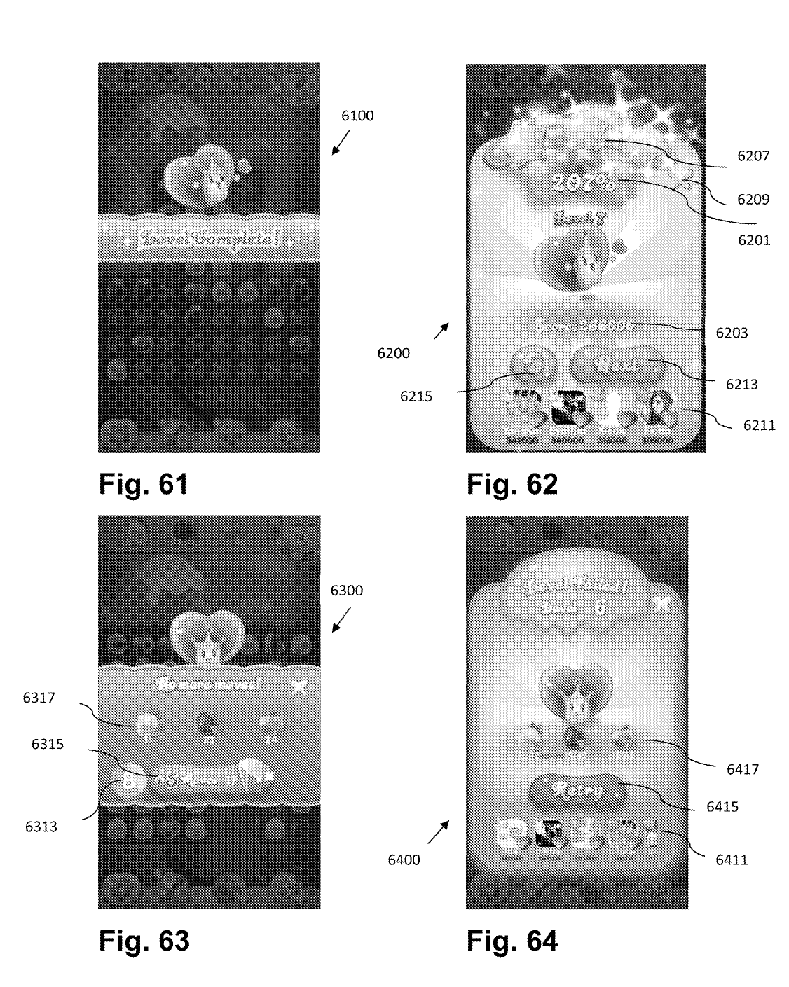

FIG. 61 illustrates an embodiment of a completion screen 6100 of a game level. If the Player has accomplished all required goals of the game level, the completion screen 6100 may be shown to notify that the Player has completed the game level. In one embodiment, the Player may simply tap, click, or press any button to proceed to the game level summary screen 6200 shown in FIG. 62. The game level summary screen 6200 may contain a level percentage completion display 6201, a total score 6203, a game level completion indicator 6307, which may correspond to a game level completion indicator shown in the game map mode and have similar functionality, and the scores 6211 on the same game level from contacts of the Player from a social networking service. In one embodiment, the game level completion indicator 6307 depends on the Player's total score, and is displayed as a number of stars, with three stars indicating a maximum range of a total score. In addition, the game level summary screen 6200 may also have a next game level icon 6213 and a game level replay icon 6215, which allow a user to move to the next game level in order and to replay the completed game level, respectively. Further, icon 6209 allows a user to exit the game level summary screen 6200. In addition, icons similar to 6209 allow a user to exit that particular screen, menu, or display.

FIG. 63 provides a failed level screen 6300 that is displayed when a player fails to complete a game level. The screen 6300 may provide a graphic informing the Player that the Player ran out of moves and/or the screen 6300 may display a Player's incomplete goals with regard to the game target indicators. Icon 6315 allows the Player to add 5 more moves for a certain amount of in-game currency. Further, the Player may be given the opportunity to add additional moves for a limited amount of time according to the timer 6313. The Player may also give up on this game level by letting the timer 6313 run out. In one embodiment, if the timer 6313 expires, failed level summary screen 6400 may be displayed to inform the Player of the game level failed and the reason for the failing to complete the level 6417 based on game target indicators. The screen 6400 may also show the Player's total score and the Player's friends' scores 6411 on the same game level. A retry icon 6415 may allow a user to back out to a game map, such the Player can select to play the same game level again or other game levels.

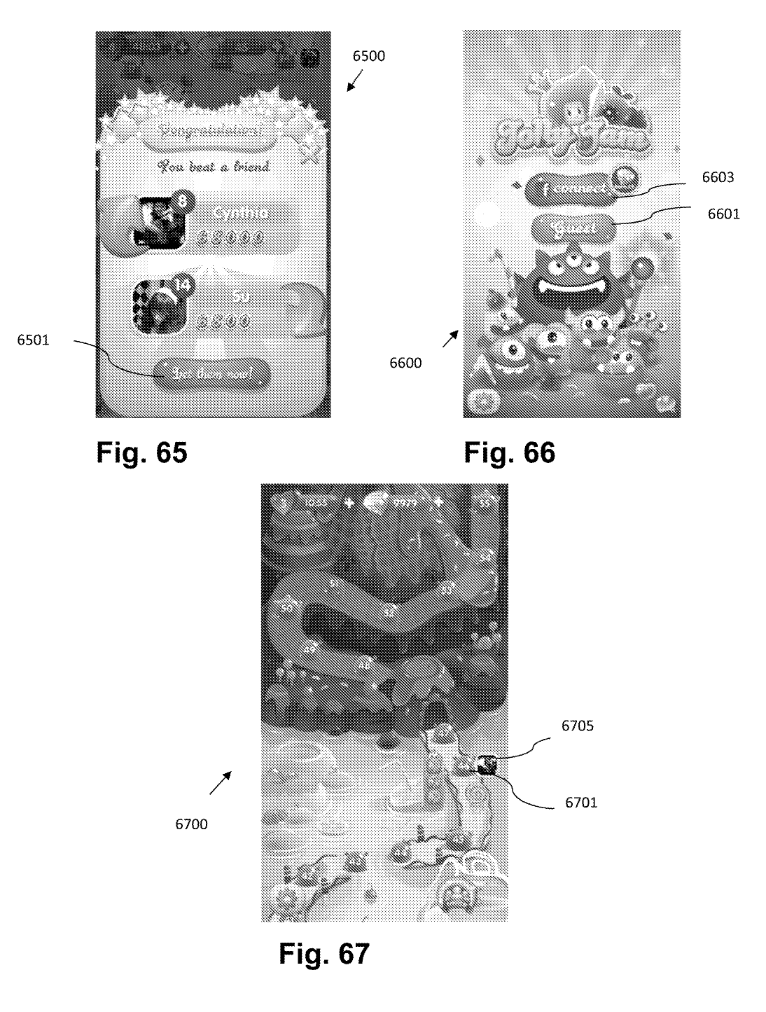

As mentioned and discussed, social networking services may play a role in various aspects of the game. A user may be connected to multiple other users of the game through a social networking service that allows information received from the social networking service to be displayed throughout different aspects of the game. In one embodiment, when a Player's total score on a certain game level exceeds a friend's total score, a notification screen 6500 as shown in FIG. 65, will appear after the Player exists from the completion screen 6100. The notification screen 6500 includes icon 6501 that will provide information to the Player's friend regarding the Player's score on a particular game level. In another embodiment, a similar screen may be presented to a Player that displays a game level score of a friend of the Player for a particular game level.

In the embodiment shown in FIG. 66, a user may initiate gameplay from initial game screen 6600 by connecting to game using an existing social network services account using icon 6603 or playing as guest using icon 6601. In one embodiment, if the Player connects to the game through a particular social network service, such as Facebook®, and turn on associated features, the Player will receive in game currency. In one embodiment, the player may receive 45 diamonds. Once connected using the social network services account, a Player may be able to keep track of the progress of social network friends that are playing game and may be able to give out gifts to those friends as well.

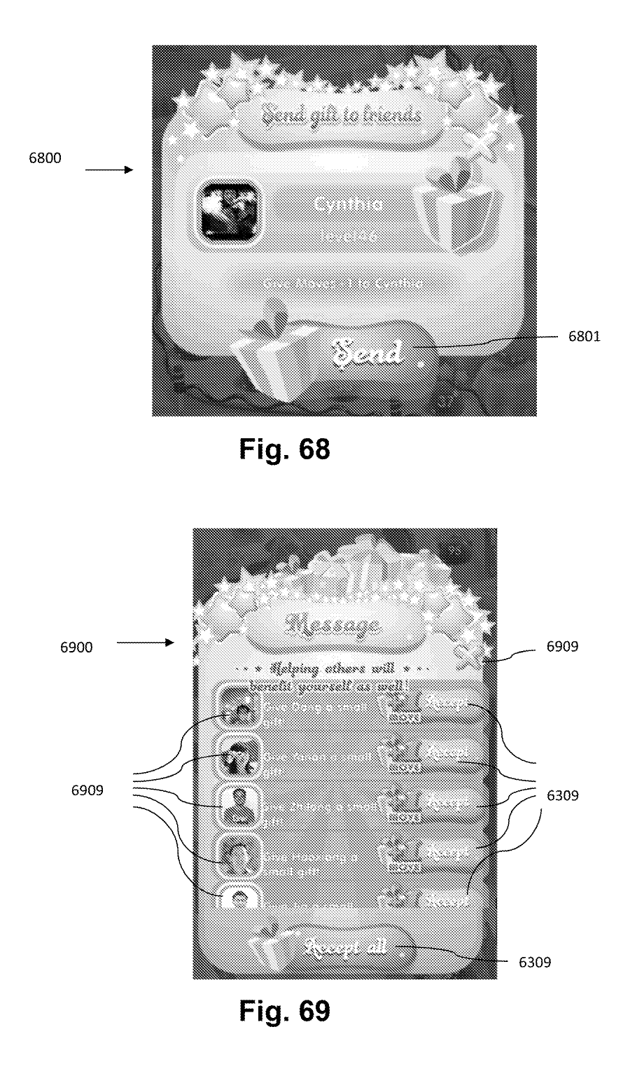

In the embodiment shown in FIG. 67, a user may to send a gift to social network contacts that are associated with the game or social network service using the icon 6705 shown in game map 6700. The icon 6705 may coincide with the current highest game level completed by the social network contact. FIG. 68 displays a social network service screen 6800 that may be displayed upon activating icon 6705. Screen 6800 includes the send icon 6801 that allows a user to confirm sending the gift to the selected social network contact. According to the embodiment of FIG. 69, when a Player connects to a social network service and enters the game, a notification screen 6900 may be displayed to inform the Player gifts from other social network contacts that are also players of the game. A Player can receive all gifts at once using icon 6309 or may accept each gift one by one using icons 6309.

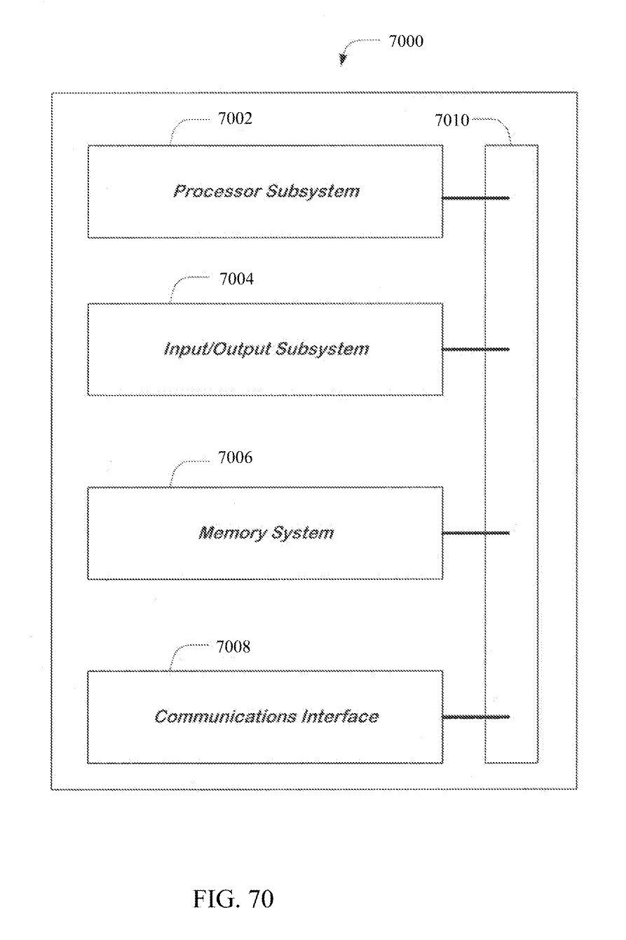

FIG. 70 is a schematic view of an illustrative electronic device 7000 capable of implementing the systems and methods described herein. Electronic device 7000 may comprise a processor subsystem 7002, an input/output subsystem 7004, a memory subsystem 7006, a communications interface 7008, and a system bus 7010. In some embodiments, one or more than one of the electronic device 7000 components may be combined or omitted such as, for example, not including the communications interface 7008. In some embodiments, the electronic device 7000 may comprise other components not combined or comprised in those shown in FIG. 70. For example, the electronic device 7000 also may comprise a power subsystem. In other embodiments, the electronic device 7000 may comprise several instances of the components shown in FIG. 70. For example, the electronic device 7000 may comprise multiple memory subsystems 7006. For the sake of conciseness and clarity, and not limitation, one of each of the components is shown in FIG. 70.

The processor subsystem 7002 may comprise any processing circuitry operative to control the operations and performance of the electronic device 7000. In various aspects, the processor subsystem 7002 may be implemented as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 7002 also may be implemented by a controller, a microcontroller, an application specific integrated circuit (ASIC), a field programmable gate array (FPGA), a programmable logic device (PLD), and so forth.

In various aspects, the processor subsystem 7002 may be arranged to run, an operating system (OS) and various mobile applications. Examples of an OS comprise, for example, operating systems generally known under the trade name of Apple OS, Microsoft Windows OS, Android OS, and any other proprietary or open source OS. Examples of mobile applications comprise, for example, a telephone application, a camera (e.g., digital camera, video camera) application, a browser application, a multimedia player application, a gaming application, a messaging application (e.g., email, short message, multimedia), a viewer application, and so forth.

In some embodiments, the electronic device 7000 may comprise a system bus 7010 that couples various system components including the processing subsystem 7002, the input/output subsystem 7004, and the memory subsystem 7006. The system bus 7010 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for mobile computing device applications.

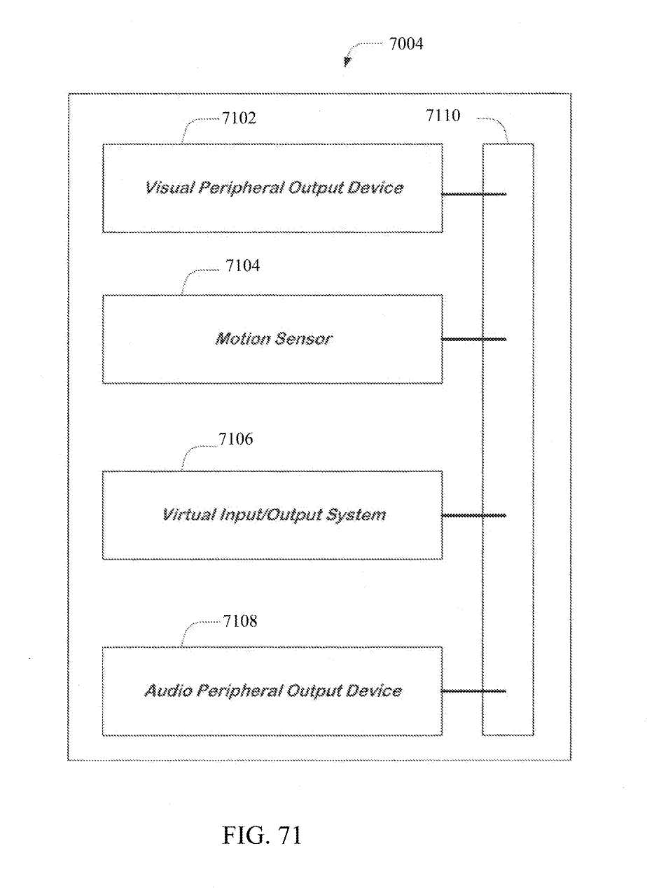

FIG. 71 shows one embodiment of the input/output subsystem 7004 of the electronic device 7000 shown in FIG. 70. The input/output subsystem 7004 may comprise any suitable mechanism or component to at least enable a user to provide input to the electronic device 7000 and the electronic device 7000 to provide output to the user. For example, the input/output subsystem 7004 may comprise any suitable input mechanism, including but not limited to, a button, keypad, keyboard, click wheel, touch screen, or motion sensor. In some embodiments, the input/output subsystem 7004 may comprise a capacitive sensing mechanism, or a multi-touch capacitive sensing mechanism. Descriptions of capacitive sensing mechanisms can be found in U.S. Patent Application Publication No. 2006/0026521, entitled “Gestures for Touch Sensitive Input Device” and U.S. Patent Publication No. 2006/0026535, entitled “Mode-Based Graphical User Interfaces for Touch Sensitive Input Device,” both of which are incorporated by reference herein in their entirety. It will be appreciated that any of the input mechanisms described herein may be implemented as physical mechanical components, virtual elements, and/or combinations thereof.

In some embodiments, the input/output subsystem 7004 may comprise specialized output circuitry associated with output devices such as, for example, an audio peripheral output device 7108. The audio peripheral output device 7108 may comprise an audio output including on or more speakers integrated into the electronic device. The speakers may be, for example, mono or stereo speakers. The audio peripheral output device 7108 also may comprise an audio component remotely coupled to audio peripheral output device 7108 such as, for example, a headset, headphones, and/or ear buds which may be coupled to the audio peripheral output device 7108 through the communications subsystem 7008.

In some embodiments, the input/output subsystem 7004 may comprise a visual peripheral output device 7102 for providing a display visible to the user. For example, the visual peripheral output device 7102 may comprise a screen such as, for example, a Liquid Crystal Display (LCD) screen, incorporated into the electronic device 7000. As another example, the visual peripheral output device 7102 may comprise a movable display or projecting system for providing a display of content on a surface remote from the electronic device 7000. In some embodiments, the visual peripheral output device 7102 can comprise a coder/decoder, also known as a Codec, to convert digital media data into analog signals. For example, the visual peripheral output device 7102 may comprise video Codecs, audio Codecs, or any other suitable type of Codec.

The visual peripheral output device 7102 also may comprise display drivers, circuitry for driving display drivers, or both. The visual peripheral output device 7102 may be operative to display content under the direction of the processor subsystem 7002. For example, the visual peripheral output device 7102 may be able to play media playback information, application screens for application implemented on the electronic device 7000, information regarding ongoing communications operations, information regarding incoming communications requests, or device operation screens, to name only a few.

In some embodiments, the input/output subsystem 7004 may comprise a motion sensor 7104. The motion sensor 204 may comprise any suitable motion sensor operative to detect movements of electronic device 7000. For example, the motion sensor 7104 may be operative to detect acceleration or deceleration of the electronic device 7000 as manipulated by a user. In some embodiments, the motion sensor 7104 may comprise one or more three-axis acceleration motion sensors (e.g., an accelerometer) operative to detect linear acceleration in three directions (i.e., the x or left/right direction, the y or up/down direction, and the z or forward/backward direction). As another example, the motion sensor 7104 may comprise one or more two-axis acceleration motion sensors which may be operative to detect linear acceleration only along each of x or left/right and y or up/down directions (or any other pair of directions). In some embodiments, the motion sensor 7104 may comprise an electrostatic capacitance (capacitance-coupling) accelerometer that is based on silicon micro-machined MEMS (Micro Electro Mechanical Systems) technology, a piezoelectric type accelerometer, a piezoresistance type accelerometer, or any other suitable accelerometer.

In some embodiments, the motion sensor 7104 may be operative to directly detect rotation, rotational movement, angular displacement, tilt, position, orientation, motion along a non-linear (e.g., arcuate) path, or any other non-linear motions. For example, when the motion sensor 7104 is a linear motion sensor, additional processing may be used to indirectly detect some or all of the non-linear motions. For example, by comparing the linear output of the motion sensor 7104 with a gravity vector (i.e., a static acceleration), the motion sensor 7104 may be operative to calculate the tilt of the electronic device 7000 with respect to the y-axis. In some embodiments, the motion sensor 7104 may instead or in addition comprise one or more gyro-motion sensors or gyroscopes for detecting rotational movement. For example, the motion sensor 7104 may comprise a rotating or vibrating element.

In some embodiments, the motion sensor 7104 may comprise one or more controllers (not shown) coupled to the accelerometers or gyroscopes. The controllers may be used to calculate a moving vector of the electronic device 7000. The moving vector maybe determined according to one or more predetermined formulas based on the movement data (e.g., x, y, and z axis moving information) provided by the accelerometers or gyroscopes.

In some embodiments, the input/output subsystem 7004 may comprise a virtual input/output system 7106. The virtual input/output system 7106 is capable of providing input/output options by combining one or more input/output components to create a virtual input type. For example, the virtual input/output system 7106 may enable a user to input information through an on-screen keyboard which utilizes the touch screen and mimics the operation of a physical keyboard or using the motion sensor 7104 to control a pointer on the screen instead of utilizing the touch screen. As another example, the virtual input/output system 7106 may enable alternative methods of input and output to enable use of the device by persons having various disabilities. For example, the virtual input/output system 7106 may convert on-screen text to spoken words to enable reading-impaired persons to operate the device.

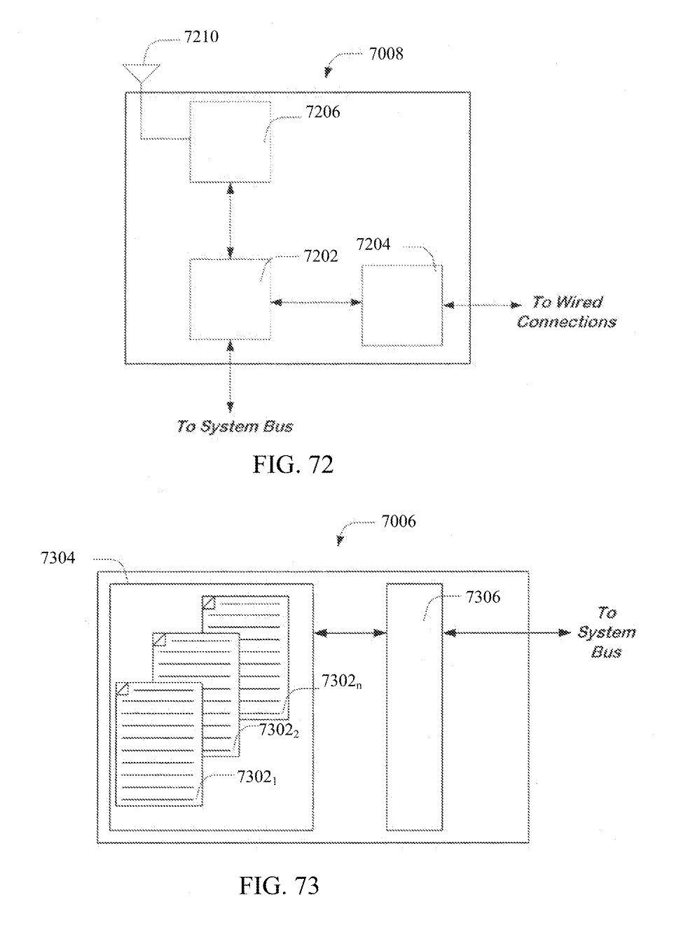

FIG. 72 shows one embodiment of the communication interface 7008. The communications interface 7008 may comprises any suitable hardware, software, or combination of hardware and software that is capable of coupling the electronic device 7000 to one or more networks and/or devices. The communications interface 7008 may be arranged to operate with any suitable technique for controlling information signals using a desired set of communications protocols, services or operating procedures. The communications interface 7008 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 7008 may comprise one or more interfaces such as, for example, a wireless communications interface 7206, a wired communications interface 7204, a network interface, a transmit interface, a receive interface, a media interface, a system interface, a component interface, a switching interface, a chip interface, a controller, and so forth. When implemented by a wireless device or within wireless system, for example, the communications interface 7008 may comprise a wireless interface 7206 comprising one or more antennas 7210, transmitters, receivers, transceivers, amplifiers, filters, control logic, and so forth.

In various aspects, the communications interface 7008 may provide voice and/or data communications functionality in accordance with different types of cellular radiotelephone systems. In various implementations, the described aspects may communicate over wireless shared media in accordance with a number of wireless protocols. Examples of wireless protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In various implementations, the described aspects may comprise part of a cellular communication system. Examples of cellular communication systems may comprise CDMA cellular radiotelephone communication systems, GSM cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) wireless standards systems such as WCDMA, CDMA-2000, UMTS cellular radiotelephone systems compliant with the Third-Generation Partnership Project (3GPP), fourth generation (4G) wireless standards, and so forth.

FIG. 73 shows one embodiment of the memory subsystem 7006. The memory subsystem 7006 may comprise any machine-readable or computer-readable media capable of storing data, including both volatile/non-volatile memory and removable/non-removable memory. The memory subsystem 7006 may comprise at least one non-volatile memory unit 7302. The non-volatile memory unit 7302 is capable of storing one or more software programs 7304₁-7304ₙ. The software programs 7304₁-7304ₙ may contain, for example, applications, user data, device data, and/or configuration data, or combinations therefore, to name only a few. The software programs 7304₁-7304ₙ may contain instructions executable by the various components of the electronic device 7000.

In various aspects, the memory subsystem 7006 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In some embodiments, the memory subsystem 7006 may contain a software program for interactive phonic learning using the capabilities of the mobile computing device 100 and the motion sensor 7104, as discussed in connection with FIGS. 70-71. In one embodiment, the memory subsystem 7006 may contain an instruction set, in the form of a file 7304ₙ for executing a method of phonic learning on the mobile computing device. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 7002.

Examples of handheld mobile devices suitable for implementing the system and method of phonic learning using a mobile computing device comprise, but are not limited to: the Apple iPhone™ and iPod™; RIM Blackberry® Curve™, Pearl™, Storm™, and Bold™; Hewlett Packard Veer; Palm® (now HP) Pixi™, Pre™; Google Nexus S™, Motorola DEFY™, Droid (generations 1-3), Droid X, Droid X2, Flipside™, Atrix™, and Citrus™; HTC Incredible™ Inspire™, Surround™, EVO™, G2™HD7, Sensation™, Thunderbolt™, and Trophy™; LG Fathom™, Optimus T™, Phoenix™, Quantum™, Revolution™, Rumor Touch™, and Vortex™; Nokia Astound™; Samsung Captivate™, Continuum™, Dart™, Droid Charge™, Exhibit™, Epic™, Fascinate™, Focus™, Galaxy S™, Gravity™, Infuse™, Replenish™, Seek™, and Vibrant™; Pantech Crossover; T-Mobile® G2™, Comet™, myTouch™; Sidekick®; Sanyo Zio™; Sony Ericsson Xperia™ Play.

Examples of tablet computing devices suitable for implementing the system and method of phonic learning using a mobile computing device comprise, but are not limited to: Acer Iconia Tab A500, the Apple iPad™ (1 and 2), Asus Eee Pad Transformer, Asus Eee Slate, Coby Kyros, Dell Streak, Hewlett Packard TouchPad, Motorola XOOM, Samsung Galaxy Tab, Archos 101 internet tablet, Archos 9 PC tablet, Blackberry PlayBook, Hewlett Packard Slate, Notion ink Adam, Toshiba Thrive, and the Viewsonic Viewpad.

In embodiments as discussed, the computer devices, systems, and apparatus described herein each contain a memory that will configure associated processors to implement the methods, steps, and functions disclosed herein. Such methods, steps, and functions can be carried out, e.g., by processing capability on mobile device, POS terminal, payment processor, acquirer, issuer, or by any combination of the foregoing. The memories could be distributed or local and the processors could be distributed or singular. The memories could be implemented as an electrical, magnetic or optical memory, or any combination of these or other types of storage devices. Moreover, the terms “memory”, “memory storage”, “memory device”, or similar terms should be construed broadly enough to encompass any information able to be read from or written to an address in the addressable space accessed by an associated processor.

The computer devices, systems and apparatus described herein may take a variety of forms including a circuit, such as for example a combinational logic circuit or a sequential logic circuit (either synchronous or asynchronous), a finite state machine, a computer, tablet, processor, microprocessor, ASIC, etc. In one embodiment, at least one of the computer devices, systems and apparatus may be include a processor and/or appropriate hardware to carry out the functions described. The processor may be configured to execute operating logic in a storage medium, the operating logic regarding the methods described herein in whole or in part. The processor may also be any one of a number of single or multi-core processors known in the art. The storage may comprise volatile and non-volatile storage media configured to store persistent and temporal (working) copy of the operating logic.

In various embodiments, operating logic may be implemented in instructions supported by the instruction set architecture (ISA) of the processor, or in higher level languages and compiled into the supported ISA. The operating logic may comprise one or more logic units or modules. The operating logic may be implemented in an object oriented manner. The operating logic may be configured to be executed in a multi-tasking and/or multi-thread manner. In other embodiments, the operating logic may be implemented in hardware such as a gate array. For various embodiments, the processor may be packaged together with the operating logic. In various embodiments, the processor may be packaged together with the operating logic to form a System in Package (SiP). In various embodiments, the processor may be integrated on the same die with the operating logic. In various embodiments, the processor may be packaged together with the operating logic 166 to form a System on Chip (SoC).

In another embodiment, at least one of the computer devices, systems and apparatus may comprise a non-transitory computer readable medium such that data regarding a flow rate of fluid through the fluid passage or fluid pressure in is stored in the non-transitory computer readable medium. The data stored in the non-transitory computer readable medium may be provided to the communication module at some point for transmitting the data to another device that receives the data. In addition, a communications module (not shown) may also be included that is configured to transmit information signals.

The functions described regarding the at least one of the computer devices, systems and apparatus and other appropriate components may be performed by hardware or software. If the functions are performed by software, the software may reside in software memory (not shown) in the controller. The software in software memory may include an ordered listing of executable instructions for implementing logical functions (i.e., “logic” that may be implement either in digital form such as digital circuitry or source code or in analog form such as analog circuitry or an analog source such an analog electrical, sound or video signal), may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions.

In the context of this document, a “computer-readable medium” and/or “signal-bearing medium” is any means that may contain, store, communicate, propagate, or transport the program for use by or in connection with the instruction execution system, apparatus, or device. The computer readable medium may selectively be, for example but not limited to, an electronic, magnetic, optical, electromagnetic, infrared, or semiconductor system, apparatus, device, or propagation medium. More specific examples “a non-exhaustive list” of the computer-readable medium would include the following: an electrical connection “electronic” having one or more wires, a portable computer diskette (magnetic), a RAM (electronic), a read-only memory “ROM” (electronic), an erasable programmable read-only memory (EPROM or Flash memory) (electronic), an optical fiber (optical), and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Aspects of the present disclosure discussed with regards to and shown in FIGS. 1-73, or any part(s) or function(s) thereof as appropriate, may be implemented using hardware, software modules, firmware, tangible computer readable media having instructions stored thereon, or a combination thereof and may be implemented in one or more computer systems or other processing systems.

Although the various embodiments of the devices have been described herein in connection with certain disclosed embodiments, many modifications and variations to those embodiments may be implemented. For example, different types of end effectors may be employed. Also, where materials are disclosed for certain components, other materials may be used. The foregoing description and following claims are intended to cover all such modification and variations.

Any patent, publication, or other disclosure material, in whole or in part, said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, said to be incorporated by reference herein, but which conflicts with existing definitions, statements, or other disclosure material set forth herein will only be incorporated to the extent that no conflict arises between that incorporated material and the existing disclosure material.

Various embodiments are described in the following numbered clauses.

1. A computer-implemented method of playing a game, the computer comprising a processor, a non-transitory memory, a display device for displaying information to a user, and an input device for receiving information and commands from the user, the method comprising: displaying a first plurality of game elements on the display device; receiving, via the input device, a selection from the user, wherein the selection comprises a first game element of the plurality of game elements and at least one second game element of the plurality of game elements, and wherein an appearance of the first game element matches an appearance of the at least one second game element; displaying the selection as an enclosed area that encompasses the first game element and the at least one second game element; determining, by the processor, a second plurality of game elements, wherein each of the second plurality of game elements have an appearance that matches the appearance of the first game element and are located within the selection; and calculating a target score, by the processor, wherein the target score is based on a number of the second plurality of game elements.
2. The method of clause 1, wherein receiving the selection from the user comprises receiving a straight line input from the first game element to the at least one second game element.
3. The method of clause 2, wherein the computer comprises a touchscreen device, wherein the touchscreen device comprises the display device and the input device, wherein receiving the selection comprises receiving a touch input from the user via the touchscreen device, and a rectangular box encompassing the first game element and the at least one second game element is displayed based on the touch input from the user.
4. The method of clause 3, wherein the rectangular box is produced by contacting a location of the first game element on the touchscreen device and dragging to a location of the at least one second game element on the touchscreen device.
5. The method of clause 1, wherein the first plurality of game elements is displayed on a game board defined by a grid having a plurality of rows, a plurality of columns, and a plurality of cells defined within the plurality of rows and the plurality of columns, wherein the first plurality of game elements is displayed within at least a portion of the plurality of cells.
6. The method of clause 5, further comprising determining whether the selection encompasses a first type of game element, and upon determining that the selection encompasses the first type of game element, at least one of: clearing all game elements from a row or a column in which the first type of game element is located on the game board, clearing all game elements from the game board that are in an area defined by the cells adjacent the first type of game element, and clearing all game elements that match an appearance of the first type of game element from the game board.
7. The method of clause 5, further comprising determining whether the received selection is a proper selection, wherein a proper selection is defined as one of: a rectangular box of cells comprising the first game element and the at least one second game element at opposite corners of the rectangular box, a column of cells comprising the first game element and the at least one second game element at opposite ends of the column of cells, and a row of cells comprising the first game element and the at least one second game element at opposite ends of the row of cells.
8. The method of clause 7, wherein upon determining that the selection is not a proper selection, displaying a notice that the selection is not a proper selection.
9. The method of clause 5, wherein at least a second portion of the plurality of cells are discontiguous.
10. The method of clause 1, further comprising clearing the second plurality of game elements from the display device, and displaying additional game elements in locations previously occupied by the second plurality of game elements.
11. The method of clause 1, wherein the selection is a first selection, wherein the number of game elements is a first number of game elements, wherein the score is a first score, and the method further comprising: receiving, via the input device, a second selection from the user, wherein the second selection comprises a third game element of the plurality of game elements and at least one fourth game element of the plurality of game elements, and wherein an appearance of the third game element matches an appearance of the at least one fourth game element; displaying the second selection as an enclosed area that encompasses the third game element and the at least one fourth game element; determining, by the processor, a third plurality of game elements, wherein each of the third plurality of game elements have an appearance that matches the appearance of the third game element and are located within the second selection; calculating a second target score, by the processor, wherein the second target score is based on a number of the third plurality of game elements; and calculating a total score, wherein the total score is based on at least the first target score and the second target score.
12. The method of clause 11, wherein calculating the total score comprises calculating the total score over a predetermined time period.
13. The method of clause 1, further comprising determining whether an appearance of a target game element matches at least one game element within the selection.
14. The method of clause 6, further comprising displaying at least one second type of game element on the display device, wherein the second type of game element is different from the first type of game element.
15. The method of clause 14, further comprising determining whether an appearance of the second type of game element matches at least one game element within the selection, and upon determining that the appearance of the second type of game element matches at least one game element within the selection, clearing the at least one second type of game element that matches the at least one game element within the selection from the display device.
16. The method of clause 1, further comprising connecting to a social networking service and displaying information received from the social networking service.
17. The method of clause 16, wherein the user is a first user, wherein the information received from the social networking service comprises a game level score of a second user, the second user associated with the first user via the social networking service.
18. The method of clause 1, further comprising displaying a number of remaining selections on the display device and incrementing the number of remaining selections based on the received selection.
19. A computer-implemented method of playing a game, the computer comprising a processor, a non-transitory memory, a display device for displaying information to a user, and an input device for receiving information and commands from the user, the method comprising: displaying, via the display device, a first plurality of game elements on the display device, wherein the first plurality of game elements is displayed on a game board defined by a grid having a plurality of rows, a plurality of columns, and a plurality of cells defined within the plurality of rows and the plurality of columns, wherein the first plurality of game elements is displayed within at least a portion of the plurality of cells; receiving, via the input device, a selection from the user, wherein the selection comprises a first game element of the plurality of game elements and at least one second game element of the plurality of game elements, and wherein an appearance of the first game element matches an appearance of the at least one second game element, and wherein receiving the selection from the user comprises receiving a straight line input from the first game element to the at least one second game element; displaying, via the display device, the selection as an enclosed area that encompasses the first game element and the at least one second game element; determining, by the processor, a second plurality of game elements, wherein each of the second plurality of game elements have an appearance that matches the appearance of the first game element and are located within the selection; determining, by the processor, whether the appearance of a target game element matches at least one game element within the second plurality of game elements, and upon determining that the appearance of the target game element matches an appearance of at least one game element within the second plurality of game elements, calculating a target score, wherein the target score is based on a number of the at least one game element within the second plurality of game elements that match the target game element; incrementing a target game element counter based on the target score; clearing the second plurality of game elements from the display device, and displaying additional game elements in locations previously occupied by the second plurality of game elements; displaying a number of remaining selections on the display device; and incrementing the number of remaining selections based on the received selection.
20. An apparatus comprising an input device, a display device, a processor coupled to a memory that stores machine executable instructions that when executed by the processor cause the processor to cause the display device to display a first plurality of game elements; receive, via the input device, a selection from the user, wherein the selection comprises a first game element of the plurality of game elements and at least one second game element of the plurality of game elements, and wherein an appearance of the first game element matches an appearance of the at least one second game element; cause the display device to display the selection as an enclosed area that encompasses the first game element and the at least one second game element; determine a second plurality of game elements, wherein each of the second plurality of game elements have an appearance that matches the appearance of the first game element and are located within the selection, and calculate a target score, wherein the target score is based on a number of the second plurality of game elements.

What is claimed is:

1. A computer-implemented method of playing a game, the computer comprising a processor, a non-transitory memory, a display device for displaying information to a user, and an input device for receiving information and commands from the user, the method comprising:
displaying a first plurality of game elements on the display device;
receiving, via the input device, a selection from the user, wherein the selection comprises a first game element of the plurality of game elements and at least one second game element of the plurality of game elements, and wherein an appearance of the first game element matches an appearance of the at least one second game element;
displaying the selection as an enclosed area that encompasses the first game element and the at least one second game element;
determining, by the processor, a second plurality of game elements, wherein each of the second plurality of game elements have an appearance that matches the appearance of the first game element and are located within the selection; and
calculating a target score, by the processor, wherein the target score is based on a number of the second plurality of game elements.

2. The method of claim 1, wherein receiving the selection from the user comprises receiving a straight line input from the first game element to the at least one second game element.

3. The method of claim 2, wherein the computer comprises a touchscreen device, wherein the touchscreen device comprises the display device and the input device, wherein receiving the selection comprises receiving a touch input from the user via the touchscreen device, and a rectangular box encompassing the first game element and the at least one second game element is displayed based on the touch input from the user.

4. The method of claim 3, wherein the rectangular box is produced by contacting a location of the first game element on the touchscreen device and dragging to a location of the at least one second game element on the touchscreen device.

5. The method of claim 1, wherein the first plurality of game elements is displayed on a game board defined by a grid having a plurality of rows, a plurality of columns, and a plurality of cells defined within the plurality of rows and the plurality of columns, wherein the first plurality of game elements is displayed within at least a portion of the plurality of cells.

6. The method of claim 5, further comprising determining whether the selection encompasses a first type of game element, and upon determining that the selection encompasses the first type of game element, at least one of: clearing all game elements from a row or a column in which the first type of game element is located on the game board, clearing all game elements from the game board that are in an area defined by the cells adjacent the first type of game element, and clearing all game elements that match an appearance of the first type of game element from the game board.

7. The method of claim 5, further comprising determining whether the received selection is a proper selection, wherein a proper selection is defined as one of: a rectangular box of cells comprising the first game element and the at least one second game element at opposite corners of the rectangular box, a column of cells comprising the first game element and the at least one second game element at opposite ends of the column of cells, and a row of cells comprising the first game element and the at least one second game element at opposite ends of the row of cells.

8. The method of claim 7, wherein upon determining that the selection is not a proper selection, displaying a notice that the selection is not a proper selection.

9. The method of claim 5, wherein at least a second portion of the plurality of cells are discontiguous.

10. The method of claim 1, further comprising clearing the second plurality of game elements from the display device, and displaying additional game elements in locations previously occupied by the second plurality of game elements.

11. The method of claim 1, wherein the selection is a first selection, wherein the number of game elements is a first number of game elements, wherein the score is a first score, and the method further comprising:
receiving, via the input device, a second selection from the user, wherein the second selection comprises a third game element of the plurality of game elements and at least one fourth game element of the plurality of game elements, and wherein an appearance of the third game element matches an appearance of the at least one fourth game element;
displaying the second selection as an enclosed area that encompasses the third game element and the at least one fourth game element;
determining, by the processor, a third plurality of game elements, wherein each of the third plurality of game elements have an appearance that matches the appearance of the third game element and are located within the second selection;
calculating a second target score, by the processor, wherein the second target score is based on a number of the third plurality of game elements; and
calculating a total score, wherein the total score is based on at least the first target score and the second target score.

12. The method of claim 11, wherein calculating the total score comprises calculating the total score over a predetermined time period.

13. The method of claim 1, further comprising determining whether an appearance of a target game element matches at least one game element within the selection.

14. The method of claim 6, further comprising displaying at least one second type of game element on the display device, wherein the second type of game element is different from the first type of game element.

15. The method of claim 14, further comprising determining whether an appearance of the second type of game element matches at least one game element within the selection, and upon determining that the appearance of the second type of game element matches at least one game element within the selection, clearing the at least one second type of game element that matches the at least one game element within the selection from the display device.

16. The method of claim 1, further comprising connecting to a social networking service and displaying information received from the social networking service.

17. The method of claim 16, wherein the user is a first user, wherein the information received from the social networking service comprises a game level score of a second user, the second user associated with the first user via the social networking service.

18. The method of claim 1, further comprising displaying a number of remaining selections on the display device and incrementing the number of remaining selections based on the received selection.

19. A computer-implemented method of playing a game, the computer comprising a processor, a non-transitory memory, a display device for displaying information to a user, and an input device for receiving information and commands from the user, the method comprising:
displaying, via the display device, a first plurality of game elements on the display device, wherein the first plurality of game elements is displayed on a game board defined by a grid having a plurality of rows, a plurality of columns, and a plurality of cells defined within the plurality of rows and the plurality of columns, wherein the first plurality of game elements is displayed within at least a portion of the plurality of cells;
receiving, via the input device, a selection from the user, wherein the selection comprises a first game element of the plurality of game elements and at least one second game element of the plurality of game elements, and wherein an appearance of the first game element matches an appearance of the at least one second game element, and wherein receiving the selection from the user comprises receiving a straight line input from the first game element to the at least one second game element;
displaying, via the display device, the selection as an enclosed area that encompasses the first game element and the at least one second game element;
determining, by the processor, a second plurality of game elements, wherein each of the second plurality of game elements have an appearance that matches the appearance of the first game element and are located within the selection;
determining, by the processor, whether the appearance of a target game element matches at least one game element within the second plurality of game elements, and upon determining that the appearance of the target game element matches an appearance of at least one game element within the second plurality of game elements, calculating a target score, wherein the target score is based on a number of the at least one game element within the second plurality of game elements that match the target game element;
incrementing a target game element counter based on the target score;
clearing the second plurality of game elements from the display device, and displaying additional game elements in locations previously occupied by the second plurality of game elements;
displaying a number of remaining selections on the display device; and
incrementing the number of remaining selections based on the received selection.

20. An apparatus comprising an input device, a display device, a processor coupled to a memory that stores machine executable instructions that when executed by the processor cause the processor to:
cause the display device to display a first plurality of game elements;
receive, via the input device, a selection from the user, wherein the selection comprises a first game element of the plurality of game elements and at least one second game element of the plurality of game elements, and wherein an appearance of the first game element matches an appearance of the at least one second game element;
cause the display device to display the selection as an enclosed area that encompasses the first game element and the at least one second game element;
determine a second plurality of game elements, wherein each of the second plurality of game elements have an appearance that matches the appearance of the first game element and are located within the selection; and
calculate a target score, wherein the target score is based on a number of the second plurality of game elements.
